(19) United States
(12) Patent Application Publication
(10) Pub. No.: US 2016/0198451 A1
(43) Pub. Date: Jul. 7, 2016

(54) RECEIVING DEVICE AND RECEIVING METHOD

(71) Applicant: FUJITSU LIMITED, Kawasaki-shi (JP)

(72) Inventor: Toshiro Sawamoto, Yokohama (JP)

(73) Assignee: FUJITSU LIMITED, Kawasaki-shi (JP)

(21) Appl. No.: 14/978,627

(22) Filed: Dec. 22, 2015

(30) Foreign Application Priority Data
Jan. 5, 2015 (JP) 2015-000167

(51) Int. Cl. H04W 72/04; H04W 72/12; H04L 1/08; H04L 1/18

(52) U.S. Cl. CPC H04W 72/0406; H04L 1/1812; H04W 72/1263; H04L 1/08

(57) ABSTRACT

A receiving device includes a controller and a receiver. The controller allocates a radio resource to receive data from each of a plurality of transmitting devices based on a total number of combinations of orthogonal sequences radio resources. Each of the orthogonal sequences is used to encode retransmission information indicating whether or not to request retransmission of data. Each of the radio resources is allocated to transmit the retransmission information. The receiver receives the data by using the allocated radio resources.

### CROSS-REFERENCE TO RELATED APPLICATION

This application is based upon and claims the benefit of priority of the prior Japanese Patent application No. 2015-000167, filed on Jan. 5, 2015, the entire contents of which are incorporated herein by reference.

### FIELD

The present invention relates to a receiving device and a receiving method.

### BACKGROUND

A wireless communication system in which a base station and a radio device perform communication by way of radio is known (see, for example, Patent Literature 1 to 4 and Non-Patent Literature 1 to 3). For example, the wireless communication system performs communication according to the LTE scheme. LTE is an abbreviation of Long Term Evolution.
[Patent Literature 1] Japanese Laid-Open Patent Publication No. 2010-212855
[Patent Literature 2] Japanese Laid-Open Patent Publication No. 2009-164976
[Patent Literature 3] Japanese Laid-Open Patent Publication No. 2013-9427
[Patent Literature 4] Japanese Laid-Open Patent Publication No. 2011-517892
[Non-Patent Literature 1] “PHICH Assignment Procedure”, 3GPP TS 36.213 V10.12.0, Section 9.1.2, March, 2014
[Non-Patent Literature 2] “Physical hybrid ARQ indicator channel”, 3GPP TS 36.211 V10.7.0, Section 6.9, February, 2013
[Non-Patent Literature 3] “Performance Evaluation on PHICH in E-UTRA”, 3GPP R1-080247, NTT DoCoMo, January, 2008

According to the LTE scheme, a base station allocates radio resources of a PUSCH to receive data (e.g. transport block) from a radio device. The PUSCH is an abbreviation of a Physical Uplink Shared Channel.

As illustrated in FIG. 1, a radio device 901 transmits data by using the allocated radio resources of the PUSCH. A base station 902 receives data from the radio device 901 by using the allocated radio resources. The base station 902 transmits retransmission information indicating whether or not to request retransmission of data from the radio device 901, to the radio device 901 by using the radio resources of a PHICH. The PHICH is an abbreviation of a Physical Hybrid Automatic Repeat Request Indicator Channel. The retransmission information indicates ACK (Acknowledgement) or NACK (Negative Acknowledgement).

The retransmission information is encoded by using orthogonal sequences and is transmitted as a plurality of modulated symbols. The base station 902 uses eight different orthogonal sequences as orthogonal sequences used to encode retransmission information as illustrated in FIG. 2. The orthogonal sequences used to encode the retransmission information are identified based on orthogonal sequence numbers.

The eight orthogonal sequences include four orthogonal sequences whose elements are real numbers (orthogonal sequences whose orthogonal sequence numbers take values of 0 to 3, respectively), and four orthogonal sequences whose elements are imaginary numbers (orthogonal sequences whose orthogonal sequence numbers take values of 4 to 7, respectively).

The four orthogonal sequences whose elements are the real numbers are Walsh codes whose lengths are 4. The four orthogonal sequences whose elements are the imaginary numbers are codes obtained by multiplying with an imaginary unit j the Walsh codes whose lengths are 4. The four orthogonal sequences whose elements are the real numbers make up a first orthogonal sequence group. The four orthogonal sequences whose elements are the imaginary numbers make up a second orthogonal sequence group.

When only one of the first orthogonal sequence group and the second orthogonal sequence group is used, the number of pieces of retransmission information for which common radio resources can be used is four. Further, when both of the first orthogonal sequence group and the second orthogonal sequence group are used, the number of pieces of retransmission information for which common radio resources can be used is eight.

According to the LTE scheme, combinations of radio resources allocated to transmit retransmission information and orthogonal sequences used to encode retransmission information are associated with minimum RB numbers and are determined in advance. Each minimum RB number is a minimum value of an RB number identifying a resource block (RB) included in a radio resource allocated to receive data. The RB is an abbreviation of a Resource Block. The minimum RB number may be described as a Lowest RB Index.

According to the LTE scheme, radio resources allocated to transmit retransmission information are identified based on a PHICH group number. An association of a combination of a PHICH group number n^{group}_{PHICH} and an orthogonal sequence number n^{SEQ}_{PHICH}, and a minimum RB number i^{lowest}^{_}^{index}_{PRB}_{_}_{RA} is represented by following formula 1 and formula 2. I_{PRB}_{_}_{RA} is I^{lowest}^{_}^{index}_{PRB}_{_}_{RA} or I^{lowest}^{_}^{index}_{PRB}_{_}_{RA}. n_{DMRS} represents a parameter associated with a cyclic shift for a DMRS, and takes a value of 0 to 7. The DMRS is an abbreviation of a Demodulation Reference Signal. The I_{PHICH} represents a predetermined parameter and takes a value of 0 and 1. The N^{group}_{PHICH} represents the number of PHICH groups. The N^{PHICH}_{SF} represents a value obtained by dividing the number of orthogonal sequences by 2, and takes 4.

n_{PHICH}^{group}={I_{PRB}_{_}_{RA}+n_{DMRS}} mod N_{PHICH}^{group}+I_{PHICH}N_{PHICH}^{group} [Mathematical Formula 1]

n_{PHICH}^{seq}=(└I_{PRB}_{_}_{RA}/N_{PHICH}^{group}┘+n_{DMRS})mod 2N_{SF}^{PHICH} [Mathematical Formula 2]

FIG. 3 illustrates an example of an association expressed by above formula 1 and formula 2. For example, as illustrated in FIG. 3, when RBs 903 of RB numbers 12 to 18 are continuously allocated to receive data from a given radio device, a PHICH group number and an orthogonal sequence number associated with minimum RB number 12 are 5 and 1, respectively.

The radio device and the base station share the above association in advance. Accordingly, the radio device can correctly receive retransmission information without notifying information indicating the above combination used to transmit retransmission information, from the base station to the radio device. Consequently, radio resources are not used to transmit information indicating the above combination used to transmit retransmission information, so that it is possible to enhance use efficiency of radio resources. The use efficiency of the radio resources is a rate of the amount of radio resources allocated to communication with respect to the amount of radio resources which can be used in the wireless communication system.

### SUMMARY

According to one aspect, a receiving device includes a controller and a receiver.

The controller allocates a radio resource to receive data from each of a plurality of transmitting devices based on a total number of combinations of orthogonal sequences and radio resources, each of the orthogonal sequences being used to encode retransmission information indicating whether or not to request retransmission of data, each of the radio resources being allocated to transmit the retransmission information.

The receiver receives the data by using the allocated radio resource.

According to another aspect, the receiving device includes a controller and a transmitter.

The controller that, when IQ multiplexing, where a first orthogonal sequence matches with an orthogonal sequence, occurs, the first orthogonal sequence being used to encode first retransmission information indicating whether or not to request retransmission of first data and transmitted by using a radio resource, the orthogonal sequence being obtained by multiplying with an imaginary unit a second orthogonal sequence used to encode second retransmission information indicating whether or not to request retransmission of second data and transmitted by using the radio resource, changes a combination used to transmit retransmission information based on a number of candidates for each of a plurality of pieces of retransmission information that causes the IQ multiplexing, the combination being a combination of an orthogonal sequence and a radio resource, the number of candidates being a number of combinations that do not cause the IQ multiplexing among combinations determined according to a predetermined rule as combinations of an orthogonal sequence and a radio resource that can be used to transmit the retransmission information.

The transmitter transmits the retransmission information by using the changed combination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view illustrating an example of retransmission control for communication in uplink;

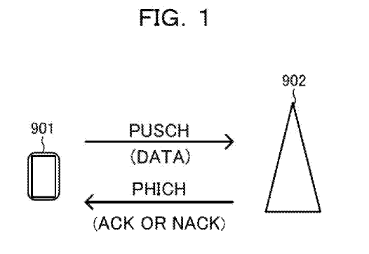

FIG. 2 is a table illustrating an example of a orthogonal codes used to encode retransmission information;

FIG. 3 is an explanatory view illustrating an example of an association of a minimum RB number, a PHICH group number and an orthogonal sequence number;

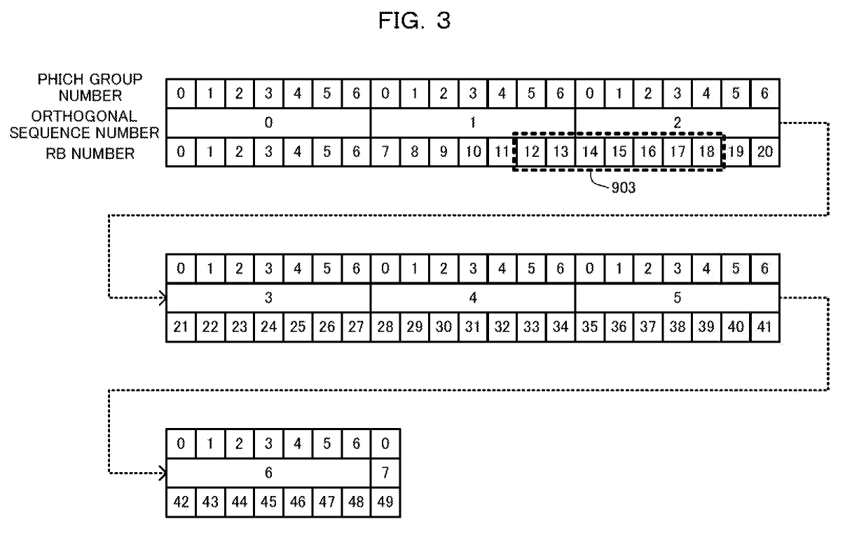

FIGS. 4A and 4B are explanatory views conceptually illustrating a relationship between transmission power and reception power of retransmission information in case where IQ multiplexing Occurs;

FIG. 5 is a block diagram illustrating an example of a configuration of a wireless communication system according to a first embodiment;

FIG. 6 is a block diagram illustrating an example of configurations of a base station and a radio device in FIG. 5;

FIG. 7 is an explanatory view illustrating an example of an allocation of radio resources;

FIG. 8 is an explanatory view illustrating an example of a plurality of allocation RB candidates used by the base station in FIG. 5;

FIG. 9 is an explanatory view illustrating an example of an allocation of radio resources;

FIG. 10 is a flowchart illustrating an example of processing executed by the base station in FIG. 5;

FIG. 11 is a block diagram illustrating an example of configurations of a base station and a radio device according to a second embodiment;

FIG. 12 is an explanatory view conceptually illustrating an example where the base station in FIG. 11 changes a combination of a radio resource and an orthogonal code;

FIG. 13 is a flowchart illustrating an example of processing executed by the base station in FIG. 11;

FIG. 14 is an explanatory view conceptually illustrating an example where a base station according to a first modified example of the second embodiment changes a combination of a radio resource and an orthogonal code;

FIG. 15 is an explanatory view conceptually illustrating an example where the base station according to the first modified example of the second embodiment changes a combination of a radio resource and an orthogonal code;

FIG. 16 is an explanatory view conceptually illustrating an example where the base station according to the first modified example of the second embodiment changes a combination of a radio resource and an orthogonal code;

FIG. 17 is an explanatory view conceptually illustrating an example where the base station according to the first modified example of the second embodiment changes a combination of a radio resource and an orthogonal code;

FIG. 18 is a flowchart illustrating an example of processing executed by the base station according to the first modified example of the second embodiment;

FIG. 19 is an explanatory view conceptually illustrating an example where the base station according to a second modified example of the second embodiment changes a combination of a radio resource and an orthogonal code; and

FIG. 20 is a flowchart illustrating an example of processing executed by the base station according to the second modified example of the second embodiment.

### DESCRIPTION OF EMBODIMENTS

When IQ multiplexing occurs, reception quality of retransmission information lowers in some cases. According to the IQ multiplexing, one of two orthogonal sequences, which are used to encode two pieces of retransmission information transmitted by using the same radio resource, matches with an orthogonal sequence obtained by multiplying the other one of the two orthogonal sequences with an imaginary unit.

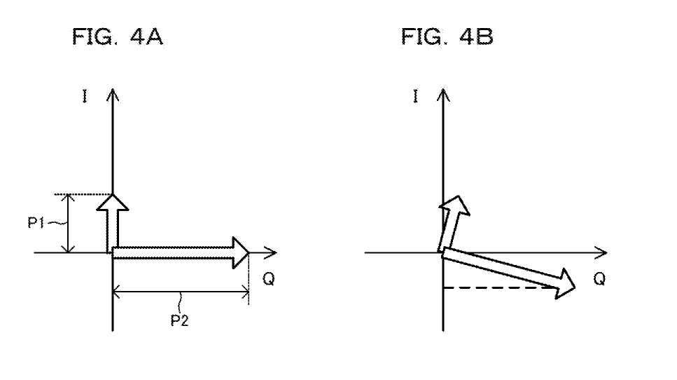

A case where, as illustrated in, for example, FIGS. 4A and 4B, transmission power P1 of first retransmission information which causes the IQ multiplexing is lower than transmission power P2 of second retransmission information which causes the IQ multiplexing will be assumed. The first retransmission information is transmitted by using the first orthogonal sequence. The second retransmission information is transmitted by using the second orthogonal sequence which is the orthogonal sequence obtained by multiplying the first orthogonal sequence with the imaginary unit.

When communication channel estimation accuracy is sufficiently high, and when a received signal is decoded by using the first orthogonal sequence, signal components deriving from the second retransmission information are hardly detected as a signal which represents the first retransmission information as illustrated in FIG. 4A. Hence, the reception quality of the retransmission information is sufficiently high in this case.

Meanwhile, when the communication channel estimation accuracy is not sufficiently high, and when a received signal is decoded by using the first orthogonal sequence, part of signal components deriving from the second retransmission information are likely to be erroneously detected as a signal representing the first retransmission information as illustrated in FIG. 4B. Hence, the reception quality of the retransmission information is likely to lower in this case.

Embodiments of the present invention will be described below with reference to the drawings. However, the embodiments described below are exemplary embodiments. Accordingly, this does not exclude an application of various deformations and techniques which are not explicitly described below to the embodiments. In addition, in the drawings used for the following embodiments, components assigned the same reference numerals will indicate the identical or same components unless changes and deformations are explicitly described.

### First Embodiment

To prevent occurrence of IQ multiplexing, a wireless communication system uses only one of a first orthogonal sequence group and a second orthogonal sequence group in some cases (see, for example, the Patent Literature 1 to 4 and the Non-Patent Literature 1 to 3). However, in this case, the number of pieces of retransmission information which can be transmitted by using a given radio resource decreases.

Further, it is considered that, when the IQ multiplexing occurs, a combination of a PHICH group number and an orthogonal sequence number used for retransmission information which causes the IQ multiplexing is changed by changing a parameter n_{DMRS} in above formula 1 and formula 2. Consequently, it is possible to prevent occurrence of the IQ multiplexing.

However, the parameter n_{DMRS} is 3-bit information. Hence, according to an information amount of the parameter n_{DMRS}, and above formula 1 and formula 2, combinations which can be used to transmit retransmission information are limited to specific combinations. Hence, for retransmission information, there is no usable combination which does not cause IQ multiplexing. Further, even when the combination is changed, if new IQ multiplexing occurs, it is not possible to avoid occurrence of the IQ multiplexing.

Hence, according to one aspect, an object of the wireless communication system according to the first embodiment is to avoid occurrence of the IQ multiplexing.

(Configuration)

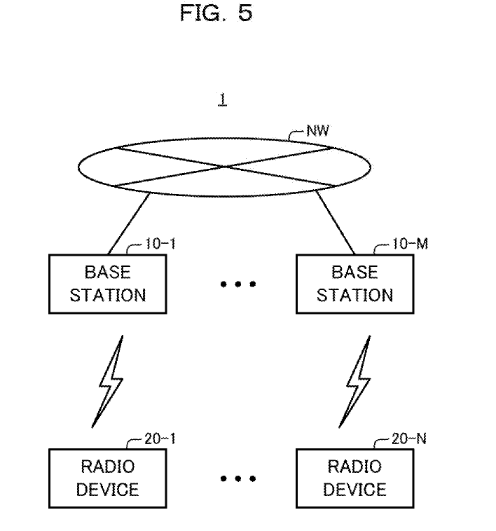

As illustrated in FIG. 5, a wireless communication system 1 according to the first embodiment illustratively includes M base stations 10-1, . . . and 10-M and N radio devices 20-1, . . . and 20-N.

In the present embodiment, M represents an integer equal to or more than 1. A base station 10-m may be referred to as a base station 10. m represents an integer of 1 to M. In the present embodiment, N represents an integer equal to or more than 1. The radio device 20-n may be referred to as a radio device 20. n represents an integer of 1 to N.

The wireless communication system 1 performs wireless communication between the base station 10 and the radio device 20 according to a predetermined wireless communication scheme. For example, the wireless communication scheme is an LTE (Long Term Evolution) scheme. In addition, the wireless communication scheme may be a scheme (e.g. a scheme such as LTE-Advanced or WiMAX) different from the LTE scheme. WiMAX is an abbreviation of Worldwide Interoperability for Microwave Access.

Each base station 10 forms a wireless area. In addition, each base station 10 may form a plurality of wireless areas. Each wireless area may be referred to as a coverage area or a communication area. For example, each wireless area may be referred to as a cell such as a macro cell, a microcell, a nano cell, a pico cell, a femto cell, a home cell, a small cell or a sector cell. Each base station 10 performs wireless communication with each radio device 20 positioned in each wireless area formed by each base station 10.

Each base station 10 is connected to a communication network (e.g. a core network) NW, so that each base station 10 is allowed to perform communication through a communication line. An interface between each base station 10 and the communication network NW may be referred to as an S1 interface. Further, an interface between the base stations 10 may be represented as an X2 interface.

A portion of the wireless communication system 1 closer to the communication network (i.e. upper class) NW than each base station 10 may be represented as an EPC. The EPC is an abbreviation of an Evolved Packet Core. A portion of the wireless communication system 1 formed by each base station 10 may be represented as E-UTRAN. E-UTRAN is an abbreviation of an Evolved Universal Terrestrial Radio Access Network.

Each radio device 20 performs wireless communication with each base station 10 which forms each wireless area by using radio resources provided in each wireless area in which each radio device 20 is positioned. In addition, the radio device 20 may be referred to as a wireless terminal, a radio device, a mobile station, a mobile terminal, a mobile device or a user terminal (UE; User Equipment). For example, the radio device 20 is a mobile telephone, a smartphone, a sensor or a meter (measuring instrument). Each radio device 20 may be carried by a user, may be mounted on a moving object such as a vehicle or may be fixed.

In the present embodiment, a radio signal transmitted from each base station 10 to each radio device 20 is represented as a radio signal in downlink. Further, in the present embodiment, a radio signal transmitted from each radio device 20 to each base station 10 is represented as a radio signal in uplink.

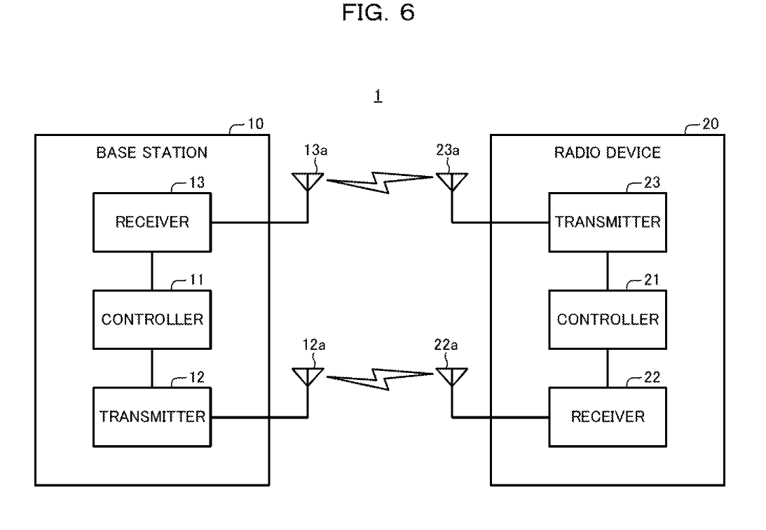

As illustrated in FIG. 6, each base station 10 illustratively includes a controller 11, a transmitter 12 and a receiver 13. Each base station 10 is an example of a receiving device.

In the present embodiment, as described above, an association of a combination of a PHICH group number and an orthogonal sequence number, and a minimum RB number is expressed as above formula 1 and formula 2. In other words, the association of a combination of a PHICH group number and an orthogonal sequence number, and a minimum RB number is determined such that the PHICH group number and the orthogonal sequence number included in the combination change as the minimum RB number increases.

The controller 11 stores in advance each association of a combination of a PHICH group number and an orthogonal sequence number, and the minimum RB number, expressed as above formula 1 and formula 2.

The controller 11 selects the radio device 20 from a plurality of radio devices 20 positioned in a wireless area formed by each base station 10, and allocates radio resources (RBs in the present embodiment) of a PUSCH to receive data from the selected radio device 20. An allocation of radio resources of the PUSCH will be described below.

In the present embodiment, a radio resource of one subcarrier corresponding to a time of one OFDM symbol according to OFDM is represented as an RE (Resource Element). OFDM is an abbreviation of Orthogonal Frequency-Division Multiplexing. In other words, each radio resource includes a plurality of REs, whose combinations of a time and a frequency are different from each other.

In the present embodiment, a period corresponding to seven REs which are continuous in a time domain is represented as a slot. Further, two slots which are continuous in the time domain form one subframe. In the present embodiment, each RB includes REs corresponding to 12 subcarriers which are continuous in a frequency domain among REs included in one slot in the time domain. Hence, in the present embodiment, one RB includes 84 (=12×7) REs.

When receiving data by using a radio resource of a PUSCH, the controller 11 obtains a combination of a PHICH group number and an orthogonal sequence number based on a minimum RB number of the radio resource allocated to receive the data, and the stored association.

The transmitter 12 includes a transmission antenna 12a, and transmits a radio signal to each radio device 20 through the transmission antenna 12a. The number of transmission antennas included in the transmitter 12 may be two or more.

The transmitter 12 transmits allocation information identifying a radio resource of the PUSCH allocated by the controller 11, to the radio device 20. For example, the allocation information is transmitted by using the radio resource of a PDCCH. The PDCCH is an abbreviation of a Physical Downlink Control Channel. The allocation information may be represented as a UL Scheduling Grant.

When receiving data by using the radio resource of the PUSCH, the transmitter 12 transmits retransmission information to the radio device 20 which is a transmission source of the data. In the present embodiment, the retransmission information is transmitted by using the radio resource of the PHICH. The retransmission information is transmitted by using the PHICH group number and the orthogonal sequence number obtained by the controller 11 for the radio resource allocated to receive the data.

The retransmission information is information which indicates ACK when the receiver 13 determines that the data has been correctly received, and is information which indicates NACK when the receiver 13 determines that the data has not been correctly received.

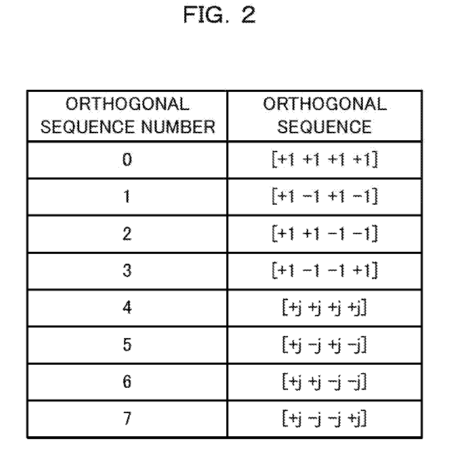

The retransmission information is encoded by using an orthogonal sequence and is transmitted as a plurality of modulated symbols. In the present embodiment, the orthogonal sequence used to encode the retransmission information is selected from eight different orthogonal sequences as illustrated in FIG. 2. The orthogonal sequence used to encode the retransmission information is identified based on an orthogonal sequence number.

In the present embodiment, as described above, an orthogonal sequence of orthogonal sequence number p is a Walsh code whose length is 4. p represents an integer of 0 to 3. An orthogonal sequence of orthogonal sequence number p+4 is a code obtained by multiplying with an imaginary unit j the orthogonal sequence of orthogonal sequence number p.

The retransmission information is transmitted by using a predetermined radio resource associated with a PHICH group number among radio resources of the PHICH. In the present embodiment, the predetermined radio resource associated with the PHICH group number includes three RE groups arranged at intervals in the frequency domain. Each RE group includes four REs which are continuous in the frequency domain.

Thus, the transmitter 12 transmits retransmission information for data by using the PHICH group number and the orthogonal sequence number associated with a minimum RB number of the radio resource allocated to receive the data.

The receiver 13 includes a reception antenna 13a, and receives a radio signal from the radio device 20 through the reception antenna 13a. The number of reception antennas included in the receiver 13 may be two or more.

The receiver 13 receives data from the radio device 20 by using the radio resource of the PUSCH allocated to the radio device 20 by the controller 11. For example, the data from the radio device 20 is newly transmitted data or retransmitted data.

When receiving the data from the radio device 20, the receiver 13 determines whether or not the data has been correctly received. For example, the receiver 13 may determine whether or not the data has been correctly received by performing error correction processing based on an error correction code.

Alternatively, each base station 10 may include an antenna and a duplexer which uses the antenna for transmission and reception in combination instead of the transmission antenna 12a and the reception antenna 13a.

As illustrated in FIG. 6, each radio device 20 illustratively includes a controller 21, a receiver 22 and a transmitter 23. Each radio device 20 is an example of a transmitting device.

The controller 21 stores in advance each association of a combination of a PHICH group number and an orthogonal sequence number, and a minimum RB number expressed by above formula 1 and formula 2.

When receiving allocation information from the base station 10, the controller 21 obtains the combination of the PHICH group number and the orthogonal sequence number based on a minimum RB number of the radio resource of the PUSCH identified based on the allocation information, and the stored association.

When receiving retransmission information from the base station 10, the controller 21 controls data transmitted by the transmitter 23 based on the retransmission information. The controller 21 controls the transmitter 23 to transmit data (untransmitted data in other words) which is transmitted for the first time (which is not yet transmitted in other words) when the retransmission information indicates ACK. The controller 21 controls the transmitter 23 to retransmit data (transmitted data in other words) which has been previously transmitted (which has already been transmitted in other words) when the retransmission information indicates NACK.

The receiver 22 includes a reception antenna 22a, and receives a radio signal from the base station 10 through the reception antenna 22a. The number of reception antennas included in the receiver 22 may be two or more.

In the present embodiment, the receiver 22 receives the allocation information and the retransmission information. The retransmission information is received by using a PHICH group number and an orthogonal sequence number obtained by the controller 21 for a radio resource identified based on the allocation information. The retransmission information is received by using a predetermined radio resource associated with the PHICH group number among the radio resources of the PHICH. The retransmission information is decoded by using an orthogonal sequence identified based on an orthogonal sequence number.

The transmitter 23 includes a transmission antenna 23a, and transmits a radio signal to the base station 10 through the transmission antenna 23a. The number of transmission antennas included in the transmitter 23 may be two or more.

When receiving allocation information from the base station 10, the transmitter 23 transmits data to the base station 10 by using the radio resource of the PUSCH identified based on the allocation information.

The transmitter 23 selects data to transmit under control of the controller 21 based on the retransmission information. In the present embodiment, as described above, the transmitter 23 transmits untransmitted data when the retransmission data indicates ACK, and retransmits transmitted data when the retransmission information indicates NACK.

Alternatively, each radio device 20 may include an antenna and a duplexer which uses the antenna for transmission and reception in combination instead of the transmission antenna 23a and the reception antenna 22a.

Next, an allocation of radio resources of the PUSCH will be additionally described.

In the present embodiment, the number of PHICH groups N^{group}_{PHICH} is expressed by following formula 3. N_{g} represents a predetermined parameter, and takes a value of ⅙, ½, 1 or 2. N^{DL}_{RB} represents the number of RBs included in each slot of a radio signal in downlink (the number of RBs corresponding to a system bandwidth in other words).

$${N}_{PHICH}^{group} = ⌈ {N}_{g} ( \frac{{N}_{RB}^{DL}}{8} ) ⌉ \qquad [ Mathematical Formula 3 ]$$

In the present embodiment, a case where the system bandwidth is 10 MHz, and a value of the parameter N_{g} is 1 will be assumed. In this case, the number of PHICH groups N^{group}_{PHICH} is 7. Alternatively, a system bandwidth may be different from 10 MHz. Alternatively, a value of the parameter N_{g} may be different from 1.

In the present embodiment, a plurality of RB numbers respectively identifying a plurality of RBs included in each slot is a plurality of continuous integers equal to or more than 0.

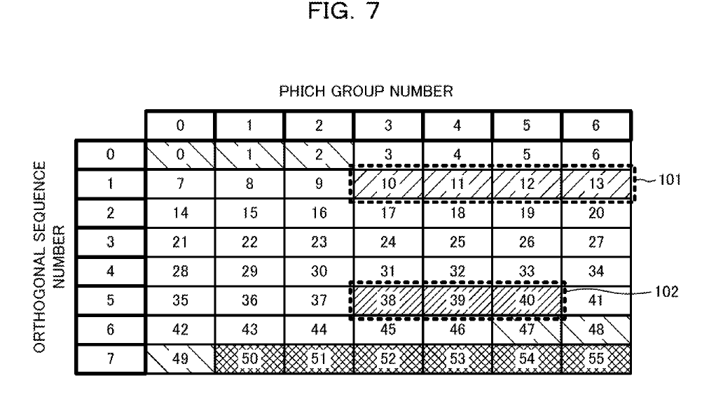

FIG. 7 illustrates an example of each association of a combination of a PHICH group number and an orthogonal sequence number, and a minimum RB number expressed by above formula 1 and formula 2.

In the present embodiment, a case where RBs of RB numbers 0 to 2 and 47 to 49 are not used as radio resources of the PUSCH will be assumed. The RBs of RB numbers 0 to 2 and 47 to 49 may be referred to as guard RBs.

Hence, in the present embodiment, RBs of RB numbers 3 to 46 can be used as radio resources of the PUSCH.

As illustrated in FIG. 7, a case where RBs 101 of RB numbers 10 to 13 are allocated to receive data from the radio device 20-1 and RBs 102 of RB numbers 38 to 40 are allocated to receive data from the radio device 20-2 will be assumed.

In this case, the minimum RB number among the RBs 101 is 10, and the minimum RB number among the RBs 102 is 38. A PHICH group number and an orthogonal sequence number associated with 10 as the minimum RB number are 3 and 1, respectively. Further, a PHICH group number and an orthogonal sequence number associated with 38 as the minimum RB number are 3 and 5, respectively.

Hence, in this case, retransmission information for the RBs 101 and retransmission information for the RBs 102 are transmitted by using the same radio resource associated with the same PHICH group number. Further, an orthogonal sequence used to encode the retransmission information for the RBs 102 matches with an orthogonal sequence obtained by multiplying with an imaginary unit the orthogonal sequence used to encode the retransmission information for the RBs 101. Hence, IQ multiplexing occurs between the retransmission information for the RBs 101 and the retransmission information for the RBs 102.

A difference between RB numbers which cause IQ multiplexing is a value obtained by dividing by 2 a product of the number of PHICH groups N^{group}_{PHICH} and the number of orthogonal sequences N^{seq}_{PHICH}. A difference between the RB numbers which cause IQ multiplexing may be referred to as an IQ offset. In the present embodiment, the value obtained by dividing the number of orthogonal sequences N^{seq}_{PHICH} by 2 is equal to the parameter N^{PHICH}_{SF}. The parameter N^{PHICH}_{SF} may be referred to as a spreading factor size. Hence, an IQ offset U_{offset} is expressed by following formula 4.

u_{offset}=N_{PHICH}^{group}·N_{SF}^{PHICH} [Mathematical Formula 4]

In the present embodiment, the IQ offset u_{offset} is 28 (=7·4) since the number of PHICH groups N^{group}_{PHICH} is 7 and the spreading factor size N^{PHICH}_{SF} is 4.

For example, the number of PHICH groups N^{group}_{PHICH} is set to each base station 10 by a point of time at which the wireless communication system 1 starts using each base station 10. Hence, each base station 10 can calculate the IQ offset by a point of time at which radio resources of the PUSCH are allocated.

In the present embodiment, the controller 11 calculates the IQ offset based on the number of PHICH groups N^{group}_{PHICH}, and the spreading factor size N^{PHICH}_{SF} obtained by dividing the number of orthogonal sequences N^{seq}_{PHICH} by 2. The controller 11 determines as a change amount a minimum value among integers different from factors of the calculated IQ offset.

In the present embodiment, the factors of the IQ offset are 1, 2, 4, 7, 14 and 28. The integers different from the factors of the IQ offset are 3, 5, 6, 8, 9, 10, 11 and . . . . Hence, the minimum value among the integers different from the factors of the IQ offset is 3.

In the present embodiment, as described above, the change amount takes a minimum value among the integers different from the factors of the IQ offset u_{offset}. Hence, the change amount is a minimum prime number among prime numbers which are different from prime factors of the IQ offset u_{offset} (which are not included in the prime factors of the IQ offset u_{offset} in other words) obtained by factorizing the IQ offset u_{offset} into the prime factors. Factorizing the IQ offset u_{offset} into the prime factors is expressed by following formula 5.

u_{offset}=π[F(k)^{a(k)}] [Mathematical Formula 5]

F(k) represents a k-th prime factor of the prime factors of the IQ offset u_{offset}. k represents an integer of 1 to the number of prime factors of the IQ offset u_{offset}. α(k) represents an index of the k-th prime factor F(k).

In addition, the integer different from the factors of the IQ offset u_{offset} being determined as the change amount is an example of the change amount being determined to avoid occurrence of IQ multiplexing.

The controller 11 determines a plurality of allocation RB candidates based on the determined change amount (3 in the present embodiment). A plurality of allocation RB candidates is a plurality of RBs identified based on a plurality of RB numbers obtained by changing a predetermined reference value by values respectively obtained by multiplying the change amount with integers among RBs which can be used as radio resources of the PUSCH.

In the present embodiment, the reference value is a minimum value (3 in the present embodiment) among RB numbers identifying RBs which can be used as radio resources of the PUSCH. Alternatively, the reference value may be a value larger than the minimum value among the RB numbers identifying the RBs which can be used as the radio resources of the PUSCH.

In the present embodiment, RB number u identifying each allocation RB candidate satisfies following formula 6. mod (X, Y) represents a remainder when X is divided by Y.

mod(u,U_{ch})=mod(U₀,U_{ch}) [Mathematical Formula 6]

U₀ represents the reference value. U_{ch} represents the change amount. u represents an integer which is the reference value U₀ or more, and is smaller than the number of RBs N^{DL}_{RB} included in each slot of the radio signal in downlink.

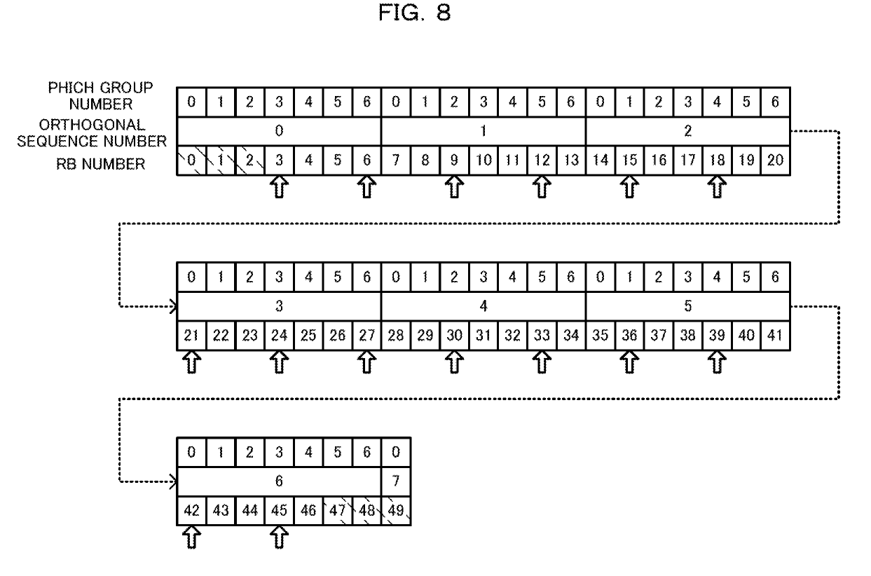

In the present embodiment, as illustrated in FIG. 8, a plurality of allocation RB candidates are 15 RBs of RB numbers 3, 6, 9, 12, 15, . . . and 45.

The controller 11 selects an allocation RB candidate which can be used to receive data from the radio device 20, from the determined plurality of allocation RB candidates, and allocates at least one RB including the RB number identifying the selected allocation RB candidate as the minimum RB number to receive the data.

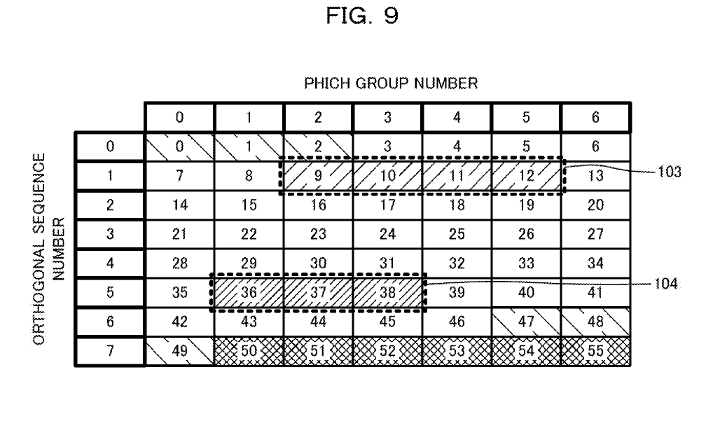

Hence, as illustrated in, for example, FIG. 9, RBs 103 of RB numbers 9 to 12 are allocated to receive data from the radio device 20-1, and RBs 104 of RB numbers 36 to 38 are allocated to receive data from the radio device 20-2.

In this case, the minimum RB number for RBs 103 is 9, and the minimum RB number for the RBs 104 is 36. A PHICH group number and an orthogonal sequence number associated with 9 as the minimum RB number are 2 and 1, respectively. A PHICH group number and an orthogonal sequence number associated with 36 as the minimum RB number are 1 and 5, respectively.

Hence, in this case, retransmission information for the RBs 103 and retransmission information for the RBs 104 are transmitted by using different radio resources associated with the different PHICH groups. Consequently, IQ multiplexing does not occur between the retransmission information for the RBs 103 and the retransmission information for the RBs 104.

(Operation)

An operation of the wireless communication system 1 will be described.

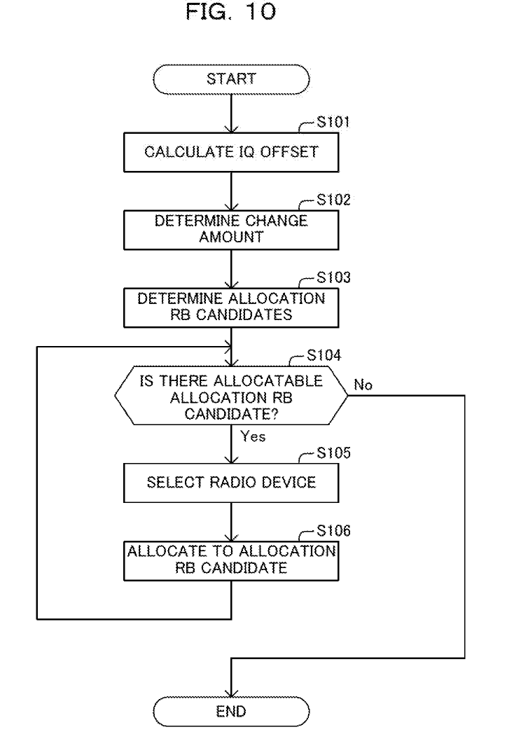

The base station 10 allocates a radio resource of the PUSCH by executing processing according to the flowchart illustrated in FIG. 10. In the present embodiment, the processing illustrated in FIG. 10 is executed every time a predetermined cycle passes.

In the present embodiment, the base station 10 calculates an IQ offset based on the number of PHICH groups N^{group}_{PHICH}, the spreading factor size N^{PHICH}_{SF} obtained by dividing the number of orthogonal sequences N^{seq}_{PHICH} by 2 and above formula 4 (step S101 in FIG. 10).

Next, the base station 10 determines as the change amount a minimum value of integers different from factors of the calculated IQ offset (step S102 in FIG. 10).

Further, the base station 10 determines a plurality of allocation RB candidates based on the determined change amount (step S103 in FIG. 10). In the present embodiment, the base station 10 determines as a plurality of allocation RB candidates a plurality of RBs identified based on a plurality of RB numbers obtained by changing a predetermined reference value by a value obtained by multiplying the change amount with an integer among RBs which can be used as radio resources of the PUSCH.

Next, the base station 10 determines whether or not there are allocation RB candidates which can be newly allocated to receive data among a plurality of determined allocation RB candidates (step S104 in FIG. 10). In the present embodiment, the base station 10 determines allocation RB candidates which are not yet allocated to receive data among a plurality of allocation RB candidates, as allocation RB candidates which can be newly allocated to receive data.

When there is no allocation RB candidate which can be newly allocated to receive data among a plurality of determined allocation RB candidates, the base station 10 determines “No” and finishes the processing in FIG. 10.

When there are allocation RB candidates which can be newly allocated to receive data among a plurality of determined allocation RB candidates, the base station 10 determines “Yes”. Next, the base station 10 selects the radio device 20 to which a radio resource is allocated to receive data, from a plurality of radio devices 20 which stands by to transmit the data (step S105 in FIG. 10).

Further, the base station 10 selects an allocation RB candidate which can be newly allocated to receive data, from a plurality of determined allocation RB candidates. Next, the base station 10 allocates at least one RB including as a minimum RB number an RB number identifying the selected allocation RB candidate to receive data from the selected radio device 20 (step S106 in FIG. 10).

Further, the base station 10 returns to step S104, and repeatedly executes processing from step S104 to step S106.

According to this, an orthogonal sequence used to encode arbitrary one of a plurality of pieces of retransmission information transmitted by using the same PHICH group number is different from an orthogonal sequence obtained by multiplying with an imaginary unit an orthogonal sequence used to encode each of the other pieces of retransmission information of a plurality of pieces of retransmission information. In other words, IQ multiplexing does not occur.

Further, the base station 10 transmits allocation information identifying the radio resource of the PUSCH allocated to receive data from each radio device 20, to the radio device 20. Thus, each radio device 20 receives the allocation information from the base station 10.

Next, each radio device 20 transmits data to the base station 10 by using the radio resource of the PUSCH identified based on the received allocation information. Thus, the base station 10 receives data from each radio device 20.

Further, the base station 10 transmits retransmission information to each radio device 20 which is a transmission source of the received data, by using a PHICH group number and an orthogonal sequence number associated with a radio resource allocated to receive each data. Thus, each radio device 20 receives the retransmission information from the base station 10.

Each radio device 20 transmits untransmitted data to the base station 10 when the received retransmission information indicates ACK, and retransmits transmitted data to the base station 10 when the received retransmission information indicates NACK.

In addition, processing from step S101 to step S103 in FIG. 10 may be executed when the processing in FIG. 10 is executed for the first time, and may not be executed when the processing in FIG. 10 is executed at the second or subsequent time. In this case, the base station 10 may store the determined allocation RB candidates when the processing in FIG. 10 is executed for the first time, and may use the stored allocation RB candidate when the processing in FIG. 10 is executed at the second or subsequent time.

As described above, the base station 10 according to the first embodiment allocates a radio resource to receive data from each radio device 20, based on a total number of combinations of orthogonal sequences used to encode retransmission information, and radio resources allocated to transmit the retransmission information.

According to this, it is possible to avoid occurrence of IQ multiplexing. As a result, it is possible to increase reception quality of retransmission information. Further, compared to a case where retransmission information is transmitted by using only a specific orthogonal sequence, it is possible to increase the number of pieces of retransmission information which can be transmitted by using a given radio resource. As a result, it is possible to enhance use efficiency of radio resources of the wireless communication system 1.

Further, the base station 10 according to the first embodiment allocates at least one RB including as a minimum RB number an integer selected from an integer group obtained by changing the predetermined reference value by a value obtained by multiplying with an integer the change amount determined based on the total number to receive data.

By contrast with this, by appropriately setting the change amount, it is possible to avoid that a difference between minimum RB numbers of radio resources allocated to receive two arbitrary items of data is an IQ offset. Consequently, it is possible to avoid occurrence of IQ multiplexing. Further, compared to a case where retransmission information is transmitted by using only a specific orthogonal sequence, it is possible to increase the number of pieces of retransmission information which can be used by using a given radio resource. As a result, it is possible to enhance use efficiency of the radio resources of the wireless communication system 1.

Further, in the base station 10 according to the first embodiment, the change amount is an integer different from factors of a value obtained by dividing the total number by 2.

According to this, it is possible to avoid that the difference between minimum RB numbers of radio resources allocated to receive two arbitrary items of data is an IQ offset. Consequently, it is possible to avoid occurrence of IQ multiplexing.

Further, in the base station 10 according to the first embodiment, the change amount is a minimum value among integers different from the factors of the value obtained by dividing the total number by 2.

As the change amount becomes smaller, the number of RBs which can be allocated to receive data becomes larger. Consequently, the base station 10 can enhance use efficiency of the radio resources of the wireless communication system 1.

In addition, the base station 10 may use as the change amount a value larger than the minimum value among the integers different from the factors of the IQ offset. For example, in the above example, the integers different from the factors of the IQ offset are 3, 5, 6, 8, 9, 10, 11 and . . . , and the minimum value among the integers different from the factors of the IQ offset is 3. In this case, the base station 10 may use 5, 6, 8, 9, 10, 11 or . . . as the change amount.

Further, the technique disclosed in the first embodiment may be applied to allocate radio resources for data communication in downlink instead of or in addition to allocation of radio resources for data communication in uplink.

The technique disclosed in the first embodiment may be applied to allocate radio resources for direction communication between the radio devices 20 instead of or in addition to allocation of radio resources for data communication in uplink. The direction communication between the radio devices 20 may be referred to as device-to-device (D2D) communication.

### Second Embodiment

Next, a wireless communication system according to the second embodiment will be described. The wireless communication system according to the second embodiment differs from the wireless communication system according to the first embodiment in adjusting an association of a PHICH group number, an orthogonal sequence number and a minimum RB number instead of controlling an allocation of radio resources of a PUSCH. Differences will be mainly described below. In addition, components assigned the same reference numerals as the reference numerals used in the first embodiment to describe the second embodiment will indicate the identical or substantially same components.

To prevent occurrence of IQ multiplexing, the wireless communication system uses only one of a first orthogonal sequence group and a second orthogonal sequence group in some cases (see, for example, the Patent Literature 1 to 4 and the Non-Patent Literature 1 to 3). However, in this case, the number of pieces of retransmission information which can be transmitted by using a given radio resource decreases.

Further, when IQ multiplexing occurs, a combination, which is used for retransmission information which causes IQ multiplexing, of a PHICH group number and an orthogonal sequence number is changed by changing a parameter n_{DMRS} in above formula 1 and formula 2. Consequently, it is possible to prevent occurrence of IQ multiplexing.

However, the parameter n_{DMRS} is 3-bit information. Hence, combinations which can be used to transmit retransmission information are limited to specific combinations according to an information amount of the parameter n_{DMRS}, and above formula 1 and formula 2. Hence, for retransmission information, there is no usable combination which does not cause IQ multiplexing. Further, even when the above combination is changed, if IQ multiplexing newly occurs, it is not possible to prevent occurrence of the IQ multiplexing in some cases.

Furthermore, a case where IQ multiplexing occurs between pieces of first and second retransmission information for which the first radio resource is used, and IQ multiplexing occurs between pieces of third and fourth retransmission information for which a second radio resource is used will be assumed. In this case, when the combination for the first retransmission information is changed, for the third and fourth retransmission information, there is no usable combination which does not cause IQ multiplexing. Thus, it is not possible to prevent occurrence of the IQ multiplexing.

Hence, according to one aspect, an object of the wireless communication system according to the second embodiment is to prevent occurrence of the IQ multiplexing.

(Configuration)

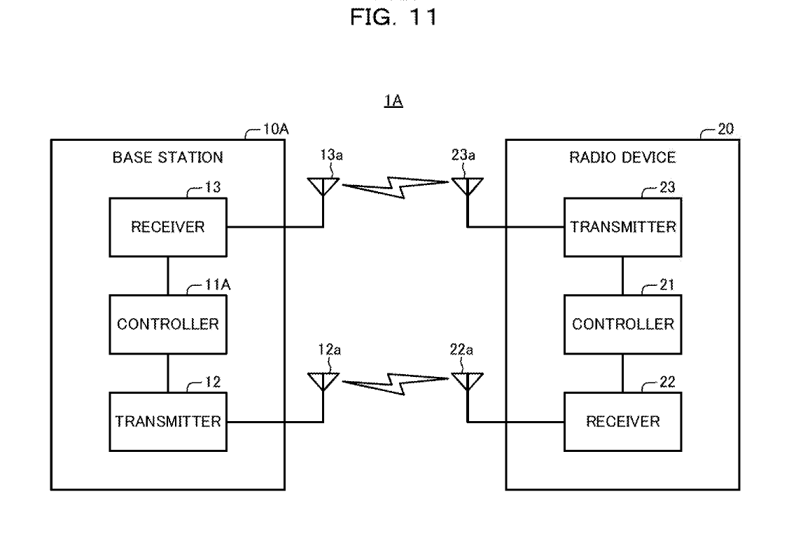

As illustrated in FIG. 11, a wireless communication system 1A according to the second embodiment differs from a wireless communication system 1 in FIG. 6 in including a base station 10A instead of a base station 10.

The base station 10A differs from the base station 10 in FIG. 6 in including a controller 11A instead of the controller 11.

The controller 11A differs from the controller 11 in a method of allocating radio resources of a PUSCH and in adjusting each association of a PHICH group number, an orthogonal sequence number and a minimum RB number.

The controller 11A stores each association of a combination of a PHICH group number and an orthogonal sequence number, a minimum RB number and the parameter n_{DMRS} expressed by above formula 1 and formula 2.

The controller 11A uses as a plurality of allocation RB candidates all RBs which can be used as radio resources of the PUSCH.

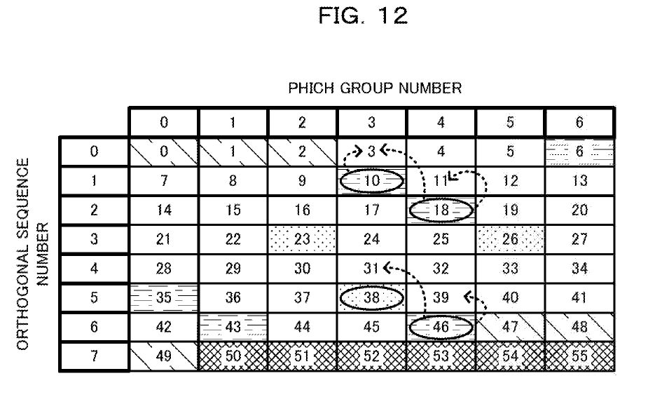

FIG. 12 illustrates an example of each association of a combination of a PHICH group number and an orthogonal sequence number, and a minimum RB number expressed by above formula 1 and formula 2.

In the present embodiment, a case where a system bandwidth is 10 MHz, and a value of a parameter N_{g} is 1 will be assumed. In this case, the number of PHICH groups N^{group}_{PHICH} is 7. Alternatively, the system bandwidth may be different from 10 MHz. Alternatively, the value of the parameter N_{g} may be different from 1.

In the present embodiment, a case where RBs of RB numbers 0 to 2 and 47 to 49 are not used as radio resources of the PUSCH will be assumed. The RBs of RB numbers 0 to 2 and 47 to 49 may be referred to as guard RBs.

Consequently, in the present embodiment, RBs whose RB numbers are 3 to 46 can be used as radio resources of the PUSCH.

In the present embodiment, the controller 11A uses as a plurality of allocation RB candidates all RBs of RB numbers 3 to 46.

When allocating radio resources of the PUSCH to receive data from each radio device 20, the controller 11A extracts IQ multiplexed RBs from RBs identified based on minimum RB numbers for the radio resources allocated to receive data from radio devices 20.

The IQ multiplexed RBs are RBs identified based on a pair of minimum RB numbers associated with a pair of combinations, each of which is of a PHICH group number and an orthogonal sequence number and which causes IQ multiplexing, according to using above formula 1 and formula 2.

In the present embodiment, the controller 11A calculates an IQ offset u_{offset} based on above formula 4, and extracts as IQ multiplexed RBs a pair of RBs whose difference between a pair of minimum RB numbers match the calculated IQ offset u_{offset}. In the present embodiment, the IQ offset u_{offset} is 28 (=7.4) since the number of PHICH group N^{group}_{PHICH} is 7 and the spreading factor size N^{PHICH}_{SF} is 4.

The controller 11A obtains the number of change candidates for each of the extracted IQ multiplexed RBs. The number of change candidates is the number of change candidates which are combinations of PHICH group numbers and orthogonal sequence numbers satisfying a predetermined change condition for the RB numbers identifying the IQ multiplexed RBs. In the present embodiment, the change condition is a condition that all of first to fourth conditions described below are satisfied.

In the present embodiment, by changing the value of the parameter n_{DMRS}, an association of the PHICH group number, the orthogonal sequence number and the minimum RB number is adjusted. In the present embodiment, the parameter n_{DMRS} is included in allocation information. By the way, data is received by using radio resources of the PUSCH when allocation information is also transmitted and when the allocation information is not transmitted.

For example, reception with Adaptive retransmission among reception of untransmitted data from each radio device 20 and reception of transmitted data from each radio device 20 is performed together with transmission of allocation information. The Adaptive retransmission is retransmission to which a different radio resource from that of previous transmission is allocated. For example, reception with Non-Adaptive retransmission among reception of transmitted data from each radio device 20 is performed without transmission of allocation information. The Non-Adaptive retransmission is retransmission to which the same radio resource as that of previous transmission is allocated.

Therefore, when data is received by using a radio resource of the PUSCH without transmission of allocation information, it is not possible to adjust an association of a combination of a PHICH group number and an orthogonal sequence number, and a minimum RB number.

Hence, the first condition is a condition that data to which an RB identified based on an RB number, for which the number of change candidates is obtained, has been allocated is received together with transmission of allocation data.

The second condition is a condition that a change candidate is one of a plurality of combinations associated with the RB number, for which the number of change candidates is obtained, according to above formula 1 and formula 2 by changing the value of the parameter n_{DMRS}.

The third condition is a condition that the same combination of the PHICH group number and the orthogonal sequence number as that of a change candidate is not used to transmit any retransmission information.

The fourth condition is a condition that a change candidate does not newly cause IQ multiplexing. In other words, the fourth condition is a condition that a combination of a PHICH group number and an orthogonal sequence number which causes IQ multiplexing together with a change candidate is not used to transmit any retransmission information.

Each combination of a PHICH group number and an orthogonal sequence number which satisfies all of the first to third conditions is an example of a combination determined according to a predetermined rule as a combination of an orthogonal sequence and a radio resource which can be used to transmit retransmission information. Each combination of a PHICH group number and an orthogonal sequence number which satisfies the change condition is an example of a combination which does not cause IQ multiplexing among combinations determined according to the predetermined rule as combinations of orthogonal sequences and radio resources which can be used to transmit retransmission information.

As illustrated in FIG. 12, a case where minimum RB numbers of radio resources allocated to receive data together with transmission of allocation information are 6, 10, 18, 35, 43 and 46 will be assumed. In this case, a case where minimum RB numbers of radio resources allocated to receive data without transmission of allocation information are 23, 26 and 38 will be assumed.

In this case, a PHICH group number and an orthogonal sequence number associated with 10 as the minimum RB number are 3 and 1, respectively. Further, a PHICH group number and an orthogonal sequence number associated with 38 as the minimum RB number are 3 and 5, respectively. Hence, in a PHICH group of PHICH group number 3, IQ multiplexing occurs. In addition, a difference between 10 as the minimum RB number and 38 as the minimum RB number matches with 28 which is an IQ offset.

Similarly, a PHICH group number and an orthogonal sequence number associated with 18 as the minimum RB number are 4 and 2, respectively. Further, a PHICH group number and an orthogonal sequence number associated with 46 as the minimum RB number are 4 and 6, respectively. Hence, in the PHICH group of PHICH group number 4, IQ multiplexing occurs. In addition, a difference between 18 as the minimum RB number and 46 as the minimum RB number matches with 28 which is an IQ offset.

Accordingly, in this case, the controller 11A extracts RBs, whose RB numbers are 10, 18, 38 and 46, as IQ multiplexed RBs. As described above, the controller 11A obtains the number of change candidates for each of the extracted IQ multiplexed RBs.

In this case, the IQ multiplexed RBs, whose RB numbers are 10, 18 and 46, are allocated to receive data together with transmission of allocation information. Hence, the first condition for the IQ multiplexed RBs, whose RB numbers are 10, 18 and 46, is satisfied. Meanwhile, the first condition for the IQ multiplexed RB, whose RB number is 38, is not satisfied. In other words, the number of change candidates for the IQ multiplexed RB, whose RB number is 38, is 0.

The second to fourth conditions for the IQ multiplexed RB, whose RB number is 10, will be additionally described.

Each of combinations of PHICH group numbers and orthogonal sequence numbers associated with 18, 26, 34, 35, 43, 51 and 3 as the RB numbers in FIG. 12 satisfies the first and second conditions.

Each of combinations of PHICH group numbers and orthogonal sequence numbers associated with 34, 51 and 3 as the RB numbers in FIG. 12 among the combinations satisfying the first and second conditions satisfies the first to third conditions.

Each of combinations of the PHICH group numbers and the orthogonal sequence numbers associated with 3 as the RB number in FIG. 12 among the combinations satisfying the first to third conditions satisfies the first to fourth conditions.

Hence, a change candidate for the IQ multiplexed RB, whose RB number is 10, is a combination whose PHICH group number and orthogonal sequence number are 3 and 0, respectively. In other words, the number of change candidates for an IQ multiplexed RB, whose RB number is 10, is 1.

The second to fourth conditions for an IQ multiplexed RB, whose RB number is 18, will be additionally described.

Each of combinations of PHICH group numbers and orthogonal sequence numbers associated with 26, 34, 35, 43, 51, 3 and 11 as the RB numbers in FIG. 12 satisfies the first and second conditions.

Each of combinations of PHICH group numbers and orthogonal sequence numbers associated with 34, 51, 3 and 11 as the RB numbers in FIG. 12 among the combinations satisfying the first and second conditions satisfies the first to third conditions.

Each of combinations of PHICH group numbers and orthogonal sequence numbers associated with 3 and 11 as the RB numbers in FIG. 12 among the combinations satisfying the first to third conditions satisfies the first to fourth conditions.

Hence, change candidates for an IQ multiplexed RB, whose RB number is 18, are a combination whose PHICH group number and orthogonal sequence number are 3 and 0, respectively, and a combination whose PHICH group number and orthogonal sequence number are 4 and 1, respectively. In other words, the number of change candidates for the IQ multiplexed RB, whose RB number is 18, is 2.

The second to fourth conditions for an IQ multiplexed RB, whose RB number is 46, will be additionally described.

Each of combinations of PHICH group numbers and orthogonal sequence numbers associated with 54, 6, 7, 15, 23, 31, 39 and 47 as the RB numbers in FIG. 12 satisfies the first and second conditions.

Each of combinations of PHICH group numbers and orthogonal sequence numbers associated with 54, 7, 15, 31 and 39 as the RB numbers in FIG. 12 among the combinations satisfying the first and second conditions satisfies the first to third conditions.

Each of combinations of PHICH group numbers and orthogonal sequence numbers associated with 31 and 39 as the RB numbers in FIG. 12 among the combinations satisfying the first to third conditions satisfies the first to fourth conditions.

Hence, change candidates for the IQ multiplexed RB, whose RB number is 46, are a combination whose PHICH group number and orthogonal sequence number are 3 and 4, respectively, and a combination whose PHICH group number and orthogonal sequence number are 4 and 5, respectively. In other words, the number of change candidates for the IQ multiplexed RB, whose RB number is 46, is 2.

In this way, the controller 11A obtains the number of change candidates for each of the extracted IQ multiplexed RBs.

The controller 11A selects an IQ multiplexed RB whose number of change candidates is minimum among the obtained numbers of change candidates and is larger than 0.

The controller 11A changes a combination of a PHICH group number and an orthogonal sequence number for the selected IQ multiplexed RB, to a combination different from a combination which is newly used in response to a change of the combination which has been made among the change candidates for the IQ multiplexed RB.

In other words, the controller 11A adjusts an association of the minimum RB number identifying the selected IQ multiplexed RB, and the combination of the PHICH group number and the orthogonal sequence number. In the present embodiment, the association of the minimum RB number and the combination of the PHICH group number and the orthogonal sequence number is adjusted by changing the value of the parameter n_{DRMS}.

The controller 11A repeats selecting an IQ multiplexed RB and changing a combination of a PHICH group number and an orthogonal sequence number for the selected IQ multiplexed RB until there is no unchanged IQ multiplexed RB among the extracted IQ multiplexed RBs. Each unchanged IQ multiplexed RB is an IQ multiplexed RB for which the combination is not changed and whose RB number is different, by an IQ offset, from an RB number identifying an IQ multiplexed RB for which the combination is not changed.

In the above case, the number of change candidates for the IQ multiplexed RB whose RB is 10 is minimum among the obtained numbers of change candidates and is larger than 0. Hence, in this case, the controller 11A first changes the combination of the PHICH group number and the orthogonal sequence number for the IQ multiplexed RB, whose RB number is 10, to a combination whose PHICH group number and orthogonal sequence number are 3 and 0, respectively.

At this point of time, there are IQ multiplexed RBs, whose RB numbers are 18 and 46, as unchanged IQ multiplexed RBs. Further, at this point of time, the number of change candidates for the IQ multiplexed RB, whose RB number is 18 or 46, is minimum among the obtained number of change candidates and is larger than 0.

Hence, the controller 11A next changes a combination of a PHICH group number and an orthogonal sequence number for an IQ multiplexed RB, whose RB number is 18, to a combination as a change candidate whose PHICH group number and orthogonal sequence number are 4 and 1, respectively.

Alternatively, the controller 11A may change the combination of the PHICH group number and the orthogonal sequence number for the IQ multiplexed RB, whose RB number is 46, to a change candidate since the number of change candidates is the same.

By the way, a case where combinations are changed in order from an IQ multiplexed RB whose number of change candidates is maximum will be assumed. In, for example, the above case, a case where the combination for the IQ multiplexed RB, whose RB number is 18, is changed to a combination whose PHICH group number and orthogonal sequence number are 3 and 0, respectively, will be assumed first. In this case, there is no change candidate which can be selected for the IQ multiplexed RB whose RB number is 10. Therefore, it is not possible to avoid occurrence of IQ multiplexing of IQ multiplexed RBs whose RB numbers are 10 and 38.

By contrast with this, the controller 11A according to the second embodiment changes combinations in order from an IQ multiplexed RB whose number of change candidates is smaller. Consequently, it is possible to prevent occurrence of IQ multiplexing. As a result, it is possible to enhance reception quality of retransmission information.

A transmitter 12 transmits allocation information including the changed parameter n_{DMRS}, to each radio device 20.

A receiver 22 receives the allocation information including the parameter n_{DMRS} from the base station 10.

A controller 21 stores each association of a combination of a PHICH group number and an orthogonal sequence number, a minimum RB number and the parameter n_{DMRS} expressed by above formula 1 and formula 2.

When receiving the allocation information from the base station 10A, the controller 21 obtains a combination of a PHICH group number and an orthogonal sequence number based on the allocation information and the stored association. In the present embodiment, the combination is obtained based on a minimum RB number for a radio resource of the PUSCH identified based on the allocation information, the parameter n_{DMRS} included in the allocation information and the stored association.

(Operation)

An operation of the wireless communication system 1A will be described.

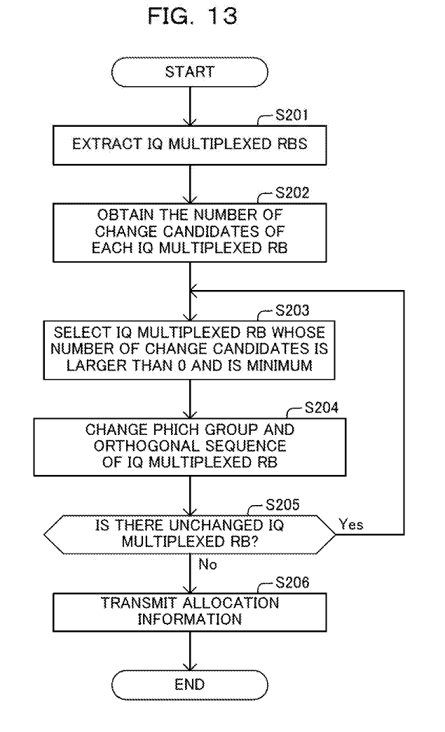

The base station 10A adjusts an association of a PHICH group number, an orthogonal sequence number and a minimum RB number by executing processing according to a flowchart illustrated in FIG. 13. In the present embodiment, the processing illustrated in FIG. 13 is executed every time a radio resource of the PUSCH is allocated.

When allocating a radio resource of the PUSCH, the base station 10A extracts IQ multiplexed RBs from RBs identified based on minimum RB numbers of the radio resources allocated to receive data from each radio device 20 (step S201 in FIG. 13).

Next, the base station 10A obtains the number of change candidates for each of the extracted IQ multiplexed RBs (step S202 in FIG. 13). Further, the base station 10A selects an IQ multiplexed RB whose number of change candidates is minimum among the obtained number of change candidates and is larger than 0 (step S203 in FIG. 13).

The base station 10A changes a combination of a PHICH group number and an orthogonal sequence number for the selected IQ multiplexed RB, to a combination different from combinations which are newly used in response to a change of a combination which has already been made among the change candidates (step S204 in FIG. 13).

Next, the base station 10A determines whether or not there is an unchanged IQ multiplexed RB among the extracted IQ multiplexed RBs. (step S205 in FIG. 13).

When there is an unchanged IQ multiplexed RB among the extracted IQ multiplexed RBs, the base station 10A determines “Yes”, returns to step S203 and repeatedly executes processing from step S203 to step S205.

Meanwhile, when there is no unchanged IQ multiplexed RB among the extracted IQ multiplexed RBs, the base station 10A determines “No”. Further, the base station 10A transmits allocation information of each radio device 20 to each radio device 20 (step S206 in FIG. 13). The allocation information of each radio device 20 is used to identify a radio resource of the PUSCH allocated to receive data from each radio device 20, and includes the parameter n_{DMRS} which supports a change of the combination made in step S205.

Next, the base station 10A finishes the processing in FIG. 13.

Thus, each radio device 20 receives the allocation information from the base station 10A.

Next, each radio device 20 transmits data to the base station 10A by using the radio resource of the PUSCH identified based on the received allocation information. Thus, the base station 10A receives the data from each radio device 20.

Further, the base station 10A transmits retransmission information to each radio device 20 which is a transmission source of the received data. The retransmission information is transmitted by using a PHICH group number and an orthogonal sequence number associated with a minimum RB number of the radio resource allocated to receive each data, and the parameter n_{DMRS} of the radio device 20.

Thus, each radio device 20 receives the retransmission information from the base station 10A. The retransmission information is received and decoded by using a PHICH group number and an orthogonal sequence number associated with a minimum RB number of a radio resource allocated to transmit data, and the parameter n_{DMRS} included in allocation information.

Each radio device 20 transmits untransmitted data to the base station 10A when the received retransmission information indicates ACK, and retransmits transmitted data to the base station 10A when the received retransmission information indicates NACK.

As described above, when IQ multiplexing occurs, the base station 10A according to the second embodiment changes a combination of a radio resource and an orthogonal sequence used to transmit retransmission information, based on the number of change candidates for each of a plurality of IQ multiplexed RBs which causes the IQ multiplexing. Further, the base station 10A transmits the retransmission information by using the changed combination. In the present embodiment, the retransmission information is transmitted in response to each IQ multiplexed RB. Hence, the number of change candidates for an IQ multiplexed RB may be referred to as the number of change candidates for retransmission information.

When a combination of a radio resource and an orthogonal sequence is changed for first retransmission information, for second retransmission information, there is no usable combination which does not IQ multiplexing.

By contrast with this, the base station 10A can change a combination used to transmit retransmission information in order from retransmission information whose number of change candidates is smaller. Consequently, when the combination for the first retransmission information is changed, it is possible to increase a probability that, for the second retransmission information, there is a usable combination which does not cause IQ multiplexing. Consequently, it is possible to prevent occurrence of IQ multiplexing. As a result, it is possible to enhance reception quality of the retransmission information.

Further, compared to a case where retransmission information is transmitted by using only a specific orthogonal sequence, it is possible to increase the number of pieces of retransmission information which can be used by using given radio resources. As a result, the wireless communication system 1A can enhance use efficiency of radio resources.

Further, the base station 10A according to the second embodiment changes the combination used to transmit retransmission information, in order from the retransmission information whose number of change candidates is smaller among IQ multiplexed RBs.

According to this, when the combination for the first retransmission information is changed, it is possible to increase a probability that, for the second retransmission information, there is a usable combination which does not IQ multiplexing. Consequently, it is possible to prevent occurrence of IQ multiplexing. As a result, it is possible to enhance reception quality of retransmission information.

Further, compared to a case where retransmission information is transmitted by using only a specific orthogonal sequence, it is possible to increase the number of pieces of retransmission information which can be transmitted by using given radio resources. As a result, the wireless communication system 1A can enhance use efficiency of radio resources.

Further, the technique disclosed in the second embodiment may be applied to allocate radio resources for data communication in downlink instead of or in addition to allocation of radio resources for data communication in uplink.

The technique disclosed in the second embodiment may be applied to allocate radio resources for direct communication between the radio devices 20 instead of or in addition to allocation of radio resources for data communication in uplink.

### First Modified Example of Second Embodiment

Next, a wireless communication system according to the first modified example of the second embodiment will be described. The wireless communication system according to the first modified example of the second embodiment differs from the wireless communication system according to the second embodiment in changing a combination when there is no change candidate. Differences will be mainly described below. In addition, components assigned the same reference numerals as reference numerals used in the second embodiment to described the first modified example of the second embodiment will indicate the identical or substantially same components.

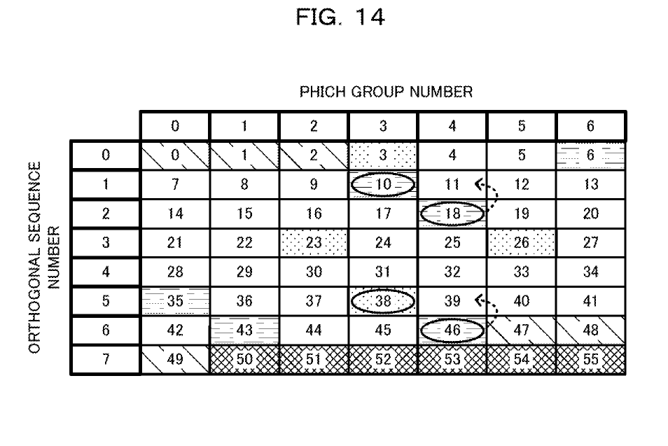

As illustrated in FIG. 14, a case where minimum RB numbers for radio resources allocated to receive data together with transmission of allocation information are 6, 10, 18, 35, 43 and 46 will be assumed. In this case, a case where minimum RB numbers for radio resources allocated to receive data without transmission of allocation information are 3, 23, 26 and 38 will be assumed.

In this case, similar to FIG. 12, a difference between 10 as the minimum RB number and 38 as the minimum RB number matches with 28 which is an IQ offset. Hence, IQ multiplexing occurs for radio resources for 10 and 38 as the minimum RB numbers. Similarly, a difference between 18 as the minimum RB number and 46 as the minimum RB number matches with 28 which is an IQ offset. Hence, IQ multiplexing occurs for radio resources of minimum RB numbers 18 and 46.

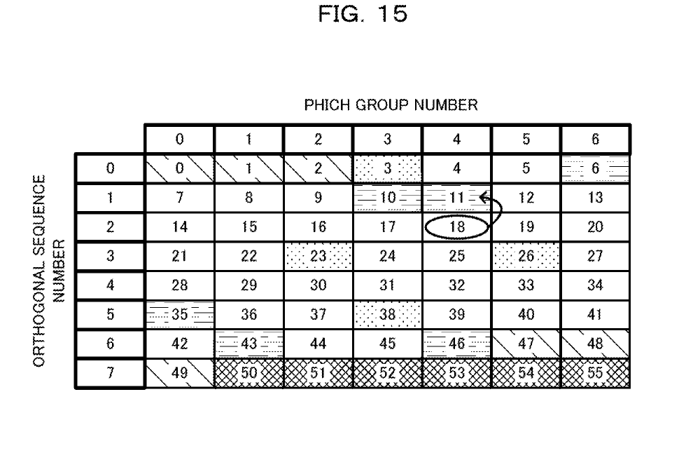

In this case, a controller 11A according to the second embodiment extracts RBs, whose RB numbers are 10, 18, 38 and 46, as IQ multiplexed RBs. Further, the controller 11A according to the second embodiment obtains 0 as the number of change candidates for the IQ multiplexed RBs, whose RB numbers are 10 and 38, and obtains 1 as the number of change candidates for the IQ multiplexed RBs whose RB numbers are 18 and 46. In addition, as illustrated in FIG. 15, the controller 11A according to the second embodiment changes a combination for the IQ multiplexed RB, whose RB number is 18, to a combination which is a change candidate and whose PHICH group number and orthogonal sequence number are 4 and 1, respectively.

However, the controller 11A according to the second embodiment cannot change the combination for the IQ multiplexed RBs whose RB numbers are 10 and 38. Therefore, the controller 11A according to the second embodiment cannot avoid occurrence of IQ multiplexing for the radio resources for which minimum RB numbers are 10 and 38.

Hence, the controller 11A according to the first modified example of the second embodiment executes extension change processing when there is an unchanged IQ multiplexed RB among the extracted IQ multiplexed RBs and there is not an IQ multiplexed RB whose number of change candidates is larger than 0.

The extension change processing will be described below.

The controller 11A extracts extension change candidates for the unchanged IQ multiplexed RBs. The extension change candidates are combinations, which satisfy a predetermined extension change condition for RB numbers used to identify IQ multiplexed RBs, of PHICH group numbers and orthogonal sequence numbers. In the present embodiment, the extension change condition is a condition that all of the fifth to eighth conditions are satisfied.

The fifth condition is a condition that data to which RBs identified based on RB numbers for which extension change candidates are extracted have been allocated is received together with transmission of allocation information.

The sixth condition is a condition that each extension change candidate is one of a plurality of combinations associated with an RB number for which each extension change candidate is extracted, according to above formula 1 and formula 2 by changing a value of a parameter n_{DMRS}.

A seventh condition is a condition that, when an RB identified based on an RB number associated with an extension change candidate according to above formula 1 and formula 2 is allocated to receive data, the data is received together with transmission of allocation information.

The eighth condition is a condition that each extension change candidate is a combination different from a pre-change combination and a changed combination in case of a change of combinations which has already been made.

Alternatively, the extension change condition may be a condition that all of the fifth to seventh conditions are satisfied.

In the above case, the controller 11A extracts combinations of PHICH group numbers and orthogonal sequence numbers associated with 34, 35, 43 and 51 as the RB numbers in FIG. 15, as extension change candidates for an IQ multiplexed RB whose RB number is 10.

Further, the controller 11A obtains the number of extension change candidates for each of the extracted extension change candidates. The number of extension change candidates is the number of change candidates which satisfy a predetermined candidate change condition for obtaining targets corresponding to the extension change candidates, and are combinations of PHICH group numbers and orthogonal sequence numbers.

The obtaining target is an extension change candidate when the extension change candidate does not cause IQ multiplexing and the same PHICH group number and orthogonal sequence number as those of the extension change candidate are used to transmit one of pieces of retransmission information. The obtaining target is a combination of a PHICH group number and an orthogonal sequence number which causes IQ multiplexing together with the extension change candidate when the extension change candidate causes IQ multiplexing and the extension change candidate is not used to transmit any retransmission information.

In the present embodiment, the candidate change condition is a condition that all of ninth to eleventh conditions are satisfied.

The ninth condition is a condition that a change candidate for an obtaining target is one of a plurality of combinations associated with the obtaining target according to above formula 1 and formula 2 by changing a value of the parameter n_{DMRS}.

The tenth condition is a condition that the same PHICH group number and orthogonal sequence number as those of the change candidate for the obtaining target are not used to transmit any retransmission information.

The eleventh condition is a condition that a change candidate for an obtaining target does not newly cause IQ multiplexing.

In the above case, obtaining the number of extension change candidates which are combinations of PHICH group numbers and orthogonal sequence numbers associated with 34 as the RB number in FIG. 15 will be additionally described.

The extension change candidate associated with 34 as the RB number in FIG. 15 causes IQ multiplexing with respect to a combination of a PHICH group number and an orthogonal sequence number associated with 6 as the RB number in FIG. 15. Further, the same PHICH group number and orthogonal sequence number as those of the extension change candidate, whose RB number is 34, are not used to transmit any retransmission information. Hence, an obtaining target for the extension change candidate, whose RB number is 34, is a combination of a PHICH group number and an orthogonal sequence number which causes IQ multiplexing together with the extension change candidate, and is associated with 6 as the RB number in FIG. 15.

The combination associated with 6 as the RB number in FIG. 15 is an example of a combination used to transmit first retransmission information which causes IQ multiplexing together with second retransmission information under an assumption that the second retransmission information is transmitted by using the combination associated with 34 as the RB number in FIG. 15.

Next, the ninth to eleventh conditions for the obtaining target for the extension change candidate associated with 34 as the RB number in FIG. 15 will be additionally described.

Each of combinations of PHICH group numbers and orthogonal sequence numbers associated with 7, 15, 23, 31, 39, 47 and 55 as the RB numbers in FIG. 15 satisfies the ninth condition.

Each of combinations of PHICH group numbers and orthogonal sequence numbers associated with 7, 15, 31, 39, 47 and 55 as the RB numbers in FIG. 15 among the combinations satisfying the ninth condition satisfies the ninth and tenth conditions.

Each of combinations of PHICH group numbers and orthogonal sequence numbers associated with 47 and 55 as the RB numbers in FIG. 15 among the combinations satisfying the ninth and tenth conditions satisfies the ninth to eleventh conditions.

Hence, change candidates for the obtaining target for the extension change candidate associated with 34 as the RB number in FIG. 15 is a combination whose PHICH group number and an orthogonal sequence number are 5 and 6, respectively, and a combination whose PHICH group number and an orthogonal sequence number are 6 and 7, respectively. In other words, the number of extension change candidates associated with 34 as the RB number in FIG. 15 is 2.

Next, obtaining the number of extension change candidates which is a combination of a PHICH group number and an orthogonal sequence number associated with 35 as the RB number in FIG. 15 will be additionally described.

The extension change candidate associated with 35 as the RB number in FIG. 15 does not cause IQ multiplexing. Further, the same PHICH group number and orthogonal sequence number as those of the extension change candidate, whose RB number 35, are used to transmit retransmission information. Hence, the obtaining target for the extension change candidate, whose RB number is 35, is the extension change candidate.

Next, the ninth to eleventh conditions for the obtaining target for the extension change candidate associated with 35 as the RB number in FIG. 15 will be additionally described.

Each of combinations of PHICH group numbers and orthogonal sequence numbers associated with 43, 51, 3, 11, 19, 27 and 28 as the RB numbers in FIG. 15 satisfies the ninth condition.

Each of combinations of PHICH group numbers and orthogonal sequence numbers associated with 51, 19, 27 and 28 as the RB numbers in FIG. 15 among the combinations satisfying the ninth condition satisfies the ninth and tenth conditions.

Each of combinations of PHICH group numbers and orthogonal sequence numbers associated with 19, 27 and 28 as the RB numbers in FIG. 15 among the combinations satisfying the ninth and tenth conditions satisfies the ninth to eleventh conditions.

Hence, change candidates for an extension change candidate associated with 35 as the RB number in FIG. 15 are a combination whose PHICH group number and orthogonal sequence number are 5 and 2, respectively, a combination whose PHICH group number and orthogonal sequence number are 6 and 3, respectively, and a combination whose PHICH group number and orthogonal sequence number are 0 and 4, respectively. In other words, the number of extension change candidates associated with 35 as the RB number in FIG. 15 is 3.

Similarly, the number of extension change candidates associated with 43 as the RB number in FIG. 15 is 4. Similarly, the number of extension change candidates associated with 51 as the RB number in FIG. 15 is 0.

The controller 11A selects an extension change candidate whose number of extension change candidates is minimum among the obtained number of extension change candidates, and is larger than 0. The controller 11A changes a combination of a PHICH group number and an orthogonal sequence number for an RB associated with the obtaining target for the selected extension change candidate, to a change candidate for the obtaining target. Further, the controller 11A changes the combination of the PHICH group number and the orthogonal sequence number for the IQ multiplexed RB, to the selected extension change candidate.

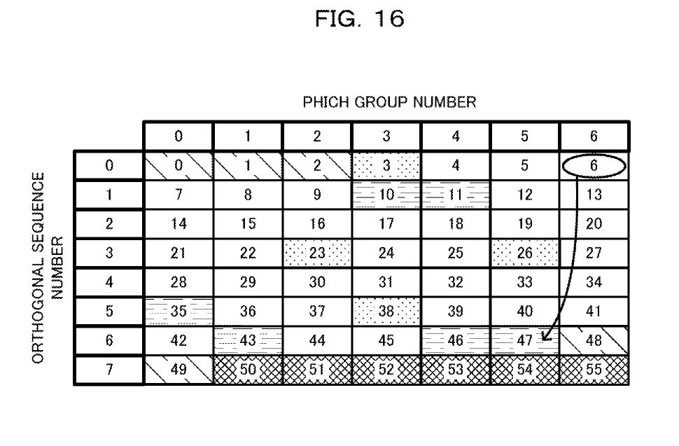

In the above case, the number of extension change candidates associated with 34 as the RB number in FIG. 15 is minimum among the obtained number of extension change candidates and is larger than 0. Hence, in this case, as illustrated in FIG. 16, the controller 11A changes a combination of a PHICH group number and an orthogonal sequence number for a radio resource whose minimum RB number is 6, to a combination whose PHICH group number and orthogonal sequence number are 5 and 6, respectively.

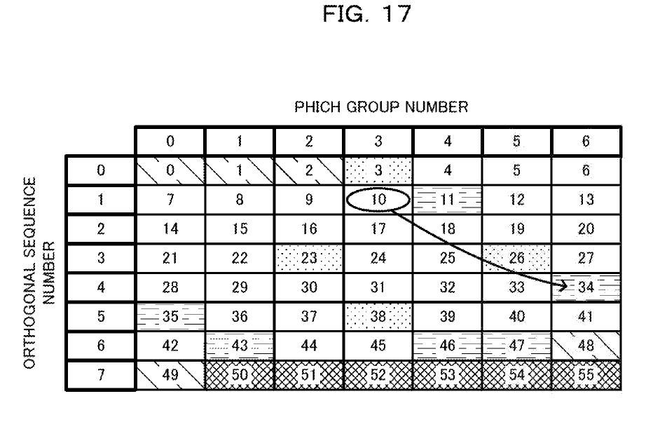

Further, as illustrated in FIG. 17, the controller 11A changes a combination of a PHICH group number and an orthogonal sequence number for an IQ multiplexed RB, whose RB number is 10, to the selected extension change candidate. The selected extension change candidate is a combination whose PHICH group number and orthogonal sequence number are 6 and 0, respectively.

Thus, extension change processing is executed.

(Operation)

An operation of the wireless communication system 1A according to the first modified example of the second embodiment will be described.

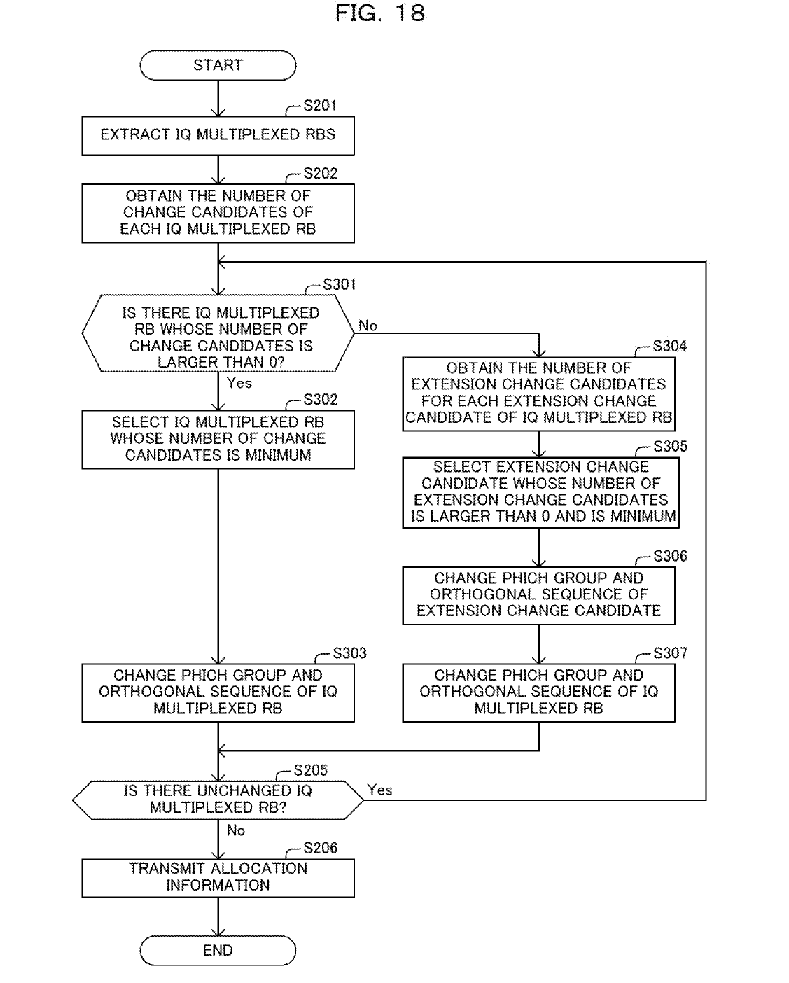

A base station 10A executes processing according to a flowchart illustrated in FIG. 18 instead of the processing in FIG. 13.

The processing in FIG. 18 is processing where processing in step S203 and step S204 in FIG. 13 is replaced with processing in step S301 to S307.

The base station 10A determines whether or not there is an IQ multiplexed RB whose obtained number of change candidates is larger than 0 after executing processing in step S202 in FIG. 18 (step S301 in FIG. 18).

When there is the IQ multiplexed RB whose obtained number of change candidates is larger than 0, the base station 10A determines “Yes” and selects an IQ multiplexed RB whose obtained number of change candidates is minimum (step S302 in FIG. 18).

The base station 10A changes a combination of a PHICH group number and an orthogonal sequence number for the selected IQ multiplexed RB, to a combination different from a combination which is newly used in response to a change of a combination which has already been made among change candidates (step S303 in FIG. 18).

Next, the base station 10A determines whether or not there is an unchanged IQ multiplexed RB among the extracted IQ multiplexed RBs (step S205 in FIG. 18).

When there is the unchanged IQ multiplexed RB among the extracted IQ multiplexed RBs, the base station 10A determines “Yes”, returns to step S301 and repeatedly executes processing from step S301 to step S205.

When there is no IQ multiplexed RB whose obtained number of change candidates is larger than 0, the base station 10A determines “No” in step S301. Further, the base station 10A extracts extension change candidates for the unchanged IQ multiplexed RB, and obtains the number of extension change candidates for each of the extracted extension change candidates (step S304 in FIG. 18).

Furthermore, the base station 10A selects an extension change candidate whose number of extension change candidates is minimum among the obtained number of extension change candidates and is larger than 0 (step S305 in FIG. 18). Next, the base station 10A changes a combination of a PHICH group number and an orthogonal sequence number for an RB associated with an obtaining target for the selected change candidate, to a change candidate for the obtaining target (step S306 in FIG. 18).

Further, the base station 10A changes a combination of the PHICH group number and an orthogonal sequence number for the unchanged IQ multiplexed RB, to the extension change candidate selected in step S305 (step S307 in FIG. 18). Next, the base station 10A moves to step S205.

As described above, the base station 10A according to the first modified example of the second embodiment provides the same function and effect as those of the base station 10A according to the second embodiment.

Further, the base station 10A according to the first modified example of the second embodiment selects an extension change candidate as a combination which can be used to transmit third retransmission information when the number of change candidates for the third retransmission information of a plurality of pieces of retransmission information which causes IQ multiplexing is 0. The extension change candidate is an example of a combination determined according to a rule as a combination which can be used to transmit the third retransmission information.

In addition, the base station 10A changes to a change candidate for an obtaining target a combination which can be used to transmit retransmission information for received data to which a radio resource of a minimum RB number associated with the obtaining target for the selected extension change candidate has been allocated. The retransmission information of the received data to which the radio resource of the minimum RB number associated with the obtaining target for the selected extension change candidate has been allocated is an example of fourth retransmission information. The change candidate for the obtaining target is an example of a combination which does not cause IQ multiplexing among combinations determined according to a rule as combinations which can be used to transmit the fourth retransmission information.

Further, the base station 10A changes a combination which is used to transmit the third retransmission information, to an extension change candidate.

According to this, when, for the third retransmission information, there is no usable combination which does not cause IQ multiplexing, it is possible to prepare for the third retransmission information a usable combination which does not cause IQ multiplexing by changing the combination for the fourth retransmission information. Consequently, it is possible to change the combination for the third retransmission information, and prevent occurrence of IQ multiplexing. As a result, it is possible to enhance reception quality of retransmission information.

### Second Modified Example of Second Embodiment

Next, a wireless communication system according to the second modified example of the second embodiment will be described. The wireless communication system according to the second modified example of the second embodiment differs from the wireless communication system according to the first modified example of the second embodiment in changing a combination when there is no extension change candidate. Differences will be mainly described below. In addition, components assigned the same reference numerals as the reference numerals in the first modified example of the second embodiment to describe the second modified example of the second embodiment will indicate the identical or substantially same components.

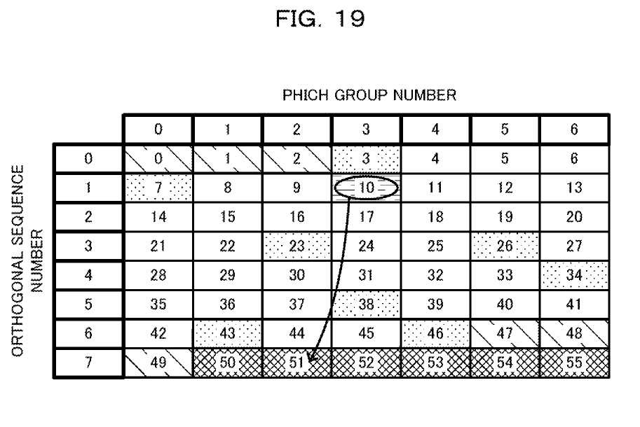

As illustrated in FIG. 19, a case where a minimum RB number for a radio resource allocated to receive data together with transmission of allocation data is 10 will be assumed. In this case, a case where minimum RB numbers for radio resources allocated to receive data without transmission of allocation information are 3, 7, 23, 26, 34, 38, 43 and 46 will be assumed.

In this case, a difference between 10 as the minimum RB number and 38 as the minimum RB number matches with 28 which is an IQ offset. Hence, IQ multiplexing occurs for radio resources for 10 and 38 as the minimum RB numbers.

In this case, a controller 11A according to the first modified example of the second embodiment extracts RBs, whose RB numbers are 10 and 38, as IQ multiplexed RBs. Further, the controller 11A according to the first modified example of the second embodiment obtains 0 as the number of change candidates for the IQ multiplexed RBs whose RB numbers are 10 and 38. In addition, the controller 11A according to the first modified example of the second embodiment obtains 0 as the number of extension change candidates for an obtaining target for each extension change candidate for the IQ multiplexed RB whose RB number is 10.

Hence, the controller 11A according to the first modified example of the second embodiment cannot change the combination for the IQ multiplexed RB of RB numbers 10 and 38. Therefore, the controller 11A according to the first modified example of the second embodiment cannot avoid occurrence of IQ multiplexing of radio resources of minimum RB numbers 10 and 38.

Hence, the controller 11A according to the second modified example of the second embodiment executes transmission power difference suppression processing when there is an unchanged IQ multiplexed RB among the extracted IQ multiplexed RBs and there is no obtaining target whose number of extension change candidates is larger than 0.

The transmission power difference suppression processing will be described below.

The controller 11A extracts a tentative selection candidate for an unchanged IQ multiplexed RB. The tentative selection candidate is a combination of a PHICH group number and an orthogonal sequence number which satisfies a predetermined selection condition for an RB number identifying an IQ multiplexed RB. In the present embodiment, the selection condition is a condition that all of thirteenth to sixteenth conditions are satisfied.

The thirteenth condition is a condition that data to which an RB identified based on an RB number for which tentative selection candidate is extracted has been allocated is received together with transmission of allocation information.

The fourteenth condition is a condition that a tentative selection candidate is one of a plurality of combinations associated with an RB number, for which the tentative selection candidate is extracted, according to above formula 1 and formula 2 by changing a value of a parameter n_{DMRS}.

The fifteenth condition is a condition that the same PHICH group number and orthogonal sequence number as those of a tentative selection candidate are not used to transmit any retransmission information.

The sixteenth condition is a condition that a tentative selection candidate is a combination different from a pre-change combination and a changed combination in response to a change of the combination which has already been made.

Alternatively, the selection condition may be a condition that all of the thirteenth to fifteenth conditions are satisfied.

The controller 11A obtains a tentative selection candidate extracted for an unchanged IQ multiplexed RB and a combination associated with an RB number of the IQ multiplexed RB by above formula 1 and formula 2, as selection candidates.

In the above case, the controller 11A obtains combinations of PHICH group numbers and orthogonal sequence numbers associated with 10, 18, 35 and 51 as the RB numbers in FIG. 19, as selection candidates for an IQ multiplexed RB whose RB number is 10.

The controller 11A obtains a transmission power difference for each obtained selection candidate. The transmission power difference is an absolute value of a difference between transmission power of retransmission information for an unchanged IQ multiplexed RB, and transmission power of retransmission information transmitted by using a combination which causes IQ multiplexing together with the selection candidate. The retransmission information transmitted by using a combination which causes IQ multiplexing together with the selection candidate is an example of first retransmission information which causes IQ multiplexing together with second retransmission information under an assumption that the second retransmission information is transmitted by using the selection candidate.

In the above case, the controller 11A obtains transmission power differences ΔP₃₈, ΔP₄₆, ΔP₇ and ΔP₂₃ for combinations of PHICH group numbers and orthogonal sequence numbers associated with 38, 46, 7 and 23 as the RB numbers in FIG. 19. The transmission power differences ΔP₃₈, ΔP₄₆, ΔP₇ and ΔP₂₃ are expressed by formula 7 to formula 10.

ΔP₃₈=|P₁₀−P₃₈| [Mathematical Formula 7]

ΔP₄₆=|P₁₀−P₄₆| [Mathematical Formula 8]

ΔP₇=|P₁₀−P₇| [Mathematical Formula 9]

ΔP₂₃=|P₁₀−P₂₃| [Mathematical Formula 10]

P₁₀, P₃₈, P₄₆, P₇ and P₂₃ represent transmission power of retransmission information transmitted by using combinations of PHICH group numbers and orthogonal sequence numbers associated with 10, 38, 46, 7 and 23 as the RB numbers in FIG. 19.

The controller 11A changes a combination of a PHICH group number and an orthogonal sequence number for an unchanged IQ multiplexed RB, to a selection candidate whose obtained transmission power difference is minimum.

In the above case, a case where the transmission power difference ΔP₂₃ for a selection candidate which is a combination of a PHICH group number and an orthogonal sequence number associated with 51 as the RB number in FIG. 19 is minimum will be assumed. In this case, as illustrated in FIG. 19, the controller 11A changes a combination of a PHICH group and an orthogonal sequence number for an IQ multiplexed RB, whose RB number is 10, to a combination whose PHICH group number and orthogonal sequence number are 2 and 7, respectively.

In addition, when the transmission power difference ΔP₃₈ for a selection candidate which is a combination of a PHICH group number and an orthogonal sequence number associated with 10 as the RB number in FIG. 19 is minimum, the controller 11A does not change a combination for the IQ multiplexed RB whose RB number is 10.

Thus, the transmission power difference suppression processing is executed.

(Operation)

An operation of the wireless communication system 1A according to the second modified example of the second embodiment will be described.

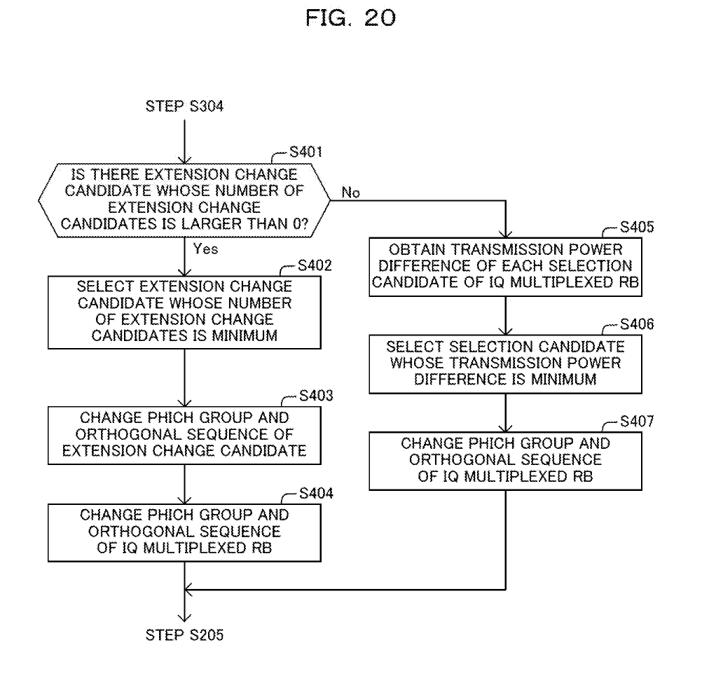

The base station 10A executes processing where processing from step S305 to step S307 in the processing in FIG. 18 is replaced with processing from step S401 to step S407 illustrated in FIG. 20 instead of the processing in FIG. 18.

The base station 10A executes the processing in step S304 in FIG. 18, and then determines whether or not there is an extension change candidate whose obtained number of extension change candidates is larger than 0 (step S401 in FIG. 20).

When there is an extension change candidate whose obtained number of extension change candidates is larger than 0, the base station 10A determines “Yes”, and selects an extension change candidate whose obtained number of extension change candidates is minimum (step S402 in FIG. 20). Further, the base station 10A executes the same processing as processing in step S306 and step S307 in FIG. 18 (step S403 and step S404 in FIG. 20). Next, the base station 10A moves to step S205 in FIG. 18.

When there is no extension change candidate whose obtained number of extension change candidates is larger than 0, the base station 10A determines “No” in step S401. Further, the base station 10A obtains a selection candidate for an unchanged IQ multiplexed RB, and obtains a transmission power difference for each of the obtained selection candidates (step S405 in FIG. 20).

Furthermore, the base station 10A selects a selection candidate whose obtained transmission power difference is minimum (step S406 in FIG. 20). Next, the base station 10A changes a combination of a PHICH group number and an orthogonal sequence number for an unchanged IQ multiplexed RB, to the selected selection candidate (step S407 in FIG. 20). Next, the base station 10A moves to step S205.

As described above, the base station 10A according to the second modified example of the second embodiment provides the same function and effect as those of the base station 10A according to the first modified example of the second embodiment.

Further, the base station 10A according to the second modified example of the second embodiment obtains a selection candidate as a combination which can be used to transmit fifth retransmission information when the number of change candidates for the fifth retransmission information among a plurality of pieces of retransmission information which causes IQ multiplexing is 0. The selection candidate is an example of at least one combination determined according to a rule as a combination which can be used to transmit the fifth retransmission information.

In addition, the base station 10A obtains a transmission power difference for each obtained selection candidate, and changes a combination used to transmit the fifth retransmission information, to a selection candidate whose obtained transmission power difference is minimum among selection candidates.

As a difference between transmission power of items of the first and second retransmission information which cause IQ multiplexing increases, a probability that retransmission information of smaller transmission power of the pieces of first and second retransmission information is received becomes higher. Consequently, the base station 10A according to the second modified example of the second embodiment can increase a probability that both pieces of the first and second retransmission information which cause IQ multiplexing are correctly received. In other words, it is possible to prevent reception quality of retransmission information from lowering.

Consequently, it is possible to enhance reception quality of retransmission information.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A receiving device comprising:
a controller that allocates a radio resource to receive data from each of a plurality of transmitting devices based on a total number of combinations of orthogonal sequences and radio resources, each of the orthogonal sequences being used to encode retransmission information indicating whether or not to request retransmission of data, each of the radio resources being allocated to transmit the retransmission information; and
a receiver that receives the data by using the allocated radio resource.

2. The receiving device according to claim 1, wherein
the radio resource includes a plurality of resource blocks identified by a plurality of continuous integers, respectively,
the receiving device further comprises a transmitter that transmits the retransmission information for the data by using the combination, the combination being associated with a minimum value of at least one integer identifying at least one resource block of the plurality of resource blocks to be allocated to receive the data, and
the controller allocates at least one resource block to receive the data, the at least one resource block of the plurality of resource blocks being identified by at least one integer including as a minimum value an integer selected from an integer group obtained by changing a predetermined reference value by a value obtained by multiplying with each of at least one integer a change amount determined based on the total number.

3. The receiving device according to claim 2, wherein
the change amount is determined such that a first orthogonal sequence is different from a second orthogonal sequence, the first orthogonal sequence being used to encode one arbitrary piece of a plurality of pieces of retransmission information transmitted by using a given radio resource, and the second orthogonal sequence being obtained by multiplying with an imaginary unit an orthogonal sequence used to encode each of other pieces of the plurality of pieces of retransmission information.

4. The receiving device according to claim 2, wherein the change amount is an integer different from a factor of a value obtained by dividing the total number by two.

5. The receiving device according to claim 2, wherein the change amount is a minimum value of integers different from a factor of a value obtained by dividing the total number by two.

6. A receiving method comprising:
allocating a radio resource to receive data from each of a plurality of transmitting devices based on a total number of combinations of orthogonal sequences and radio resources, each of the orthogonal sequences being used to encode retransmission information indicating whether or not to request retransmission of data, each of the radio resources being allocated to transmit the retransmission information; and
receiving the data by using the allocated radio resource.

7. The receiving method according to claim 6, wherein
the radio resource includes a plurality of resource blocks identified by a plurality of continuous integers, respectively, and
the receiving method further comprises: transmitting the retransmission information for the data by using the combination, the combination being associated with a minimum value of at least one integer identifying at least one resource block of the plurality of resource blocks to be allocated to receive the data; and
allocating at least one resource block to receive the data, the at least one resource block of the plurality of resource blocks being identified by at least one integer including as a minimum value an integer selected from an integer group obtained by changing a predetermined reference value by a value obtained by multiplying with each of at least one integer a change amount determined based on the total number.

8. The receiving method according to claim 7, wherein the change amount is determined such that a first orthogonal sequence is different from a second orthogonal sequence, the first orthogonal sequence being used to encode one arbitrary piece of a plurality of pieces of retransmission information transmitted by using a given radio resource, and the second orthogonal sequence being obtained by multiplying with an imaginary unit an orthogonal sequence used to encode each of other pieces of the plurality of pieces of retransmission information.

9. The receiving method according to claim 7, wherein the change amount is an integer different from a factor of a value obtained by dividing the total number by two.

10. The receiving method according to claim 7, wherein the change amount is a minimum value of integers different from a factor of a value obtained by dividing the total number by two.

11. A receiving device comprising:
a controller that, when IQ multiplexing, where a first orthogonal sequence matches with an orthogonal sequence, occurs, the first orthogonal sequence being used to encode first retransmission information indicating whether or not to request retransmission of first data and transmitted by using a radio resource, the orthogonal sequence being obtained by multiplying with an imaginary unit a second orthogonal sequence used to encode second retransmission information indicating whether or not to request retransmission of second data and transmitted by using the radio resource, changes a combination used to transmit retransmission information based on a number of candidates for each of a plurality of pieces of retransmission information that causes the IQ multiplexing, the combination being a combination of an orthogonal sequence and a radio resource, the number of candidates being a number of combinations that do not cause the IQ multiplexing among combinations determined according to a predetermined rule as combinations of an orthogonal sequence and a radio resource that can be used to transmit the retransmission information; and
a transmitter that transmits the retransmission information by using the changed combination.

12. The receiving device according to claim 11, wherein, in order from retransmission information whose number of candidates is smaller among the plurality of pieces of retransmission information that causes the IQ multiplexing, the controller changes a combination used to transmit the retransmission information, to a combination that does not cause the IQ multiplexing among the combinations determined according to the rule as combinations that can be used to transmit the retransmission information.

13. The receiving device according to claim 11, wherein the controller
selects a first combination when the number of candidates of third retransmission information is 0, the third retransmission information being one of the plurality of pieces of retransmission information that causes the IQ multiplexing, the first combination being one of combinations determined according to the rule as combinations that can be used to transmit the third retransmission information, and
changes a combination used to transmit fourth retransmission information, to a second combination that does not cause the IQ multiplexing, the second combination being one of combinations determined according to the rule as combinations that can be used to transmit the fourth retransmission information, the fourth retransmission information causing the IQ multiplexing together with the retransmission information under an assumption that the retransmission information is transmitted by using the selected first combination or the fourth retransmission information being transmitted by using the selected first combination, and
changes to the first combination the combination used to transmit the third retransmission information.

14. The receiving device according to claim 11, wherein the controller
obtains a transmission power difference when the number of candidates for fifth retransmission information is 0, the fifth retransmission information being one of the plurality of pieces of retransmission information that causes the IQ multiplexing, the transmission power difference being a difference between transmission power of the fifth retransmission information and transmission power of retransmission information that causes the IQ multiplexing together with retransmission information under an assumption that the retransmission information is transmitted by using each of at least one combination determined according to the rule as combinations that can be used to transmit the fifth retransmission information, and
changes a combination used to transmit the fifth retransmission information, to a combination whose obtained transmission power difference is minimum.

15. A receiving method comprising:
when IQ multiplexing, where a first orthogonal sequence matches with an orthogonal sequence, occurs, the first orthogonal sequence being used to encode first retransmission information indicating whether or not to request retransmission of first data and transmitted by using a radio resource, the orthogonal sequence being obtained by multiplying with an imaginary unit a second orthogonal sequence used to encode second retransmission information indicating whether or not to request retransmission of second data and transmitted by using the radio resource, changing a combination used to transmit retransmission information based on a number of candidates for each of a plurality of pieces of retransmission information that causes the IQ multiplexing, the combination being a combination of an orthogonal sequence and a radio resource, the number of candidates being a number of combinations that do not cause the IQ multiplexing among combinations determined according to a predetermined rule as combinations of an orthogonal sequence and a radio resource that can be used to transmit the retransmission information; and
transmitting the retransmission information by using the changed combination.

16. The receiving method according to claim 15, wherein, in order from retransmission information whose number of candidates is smaller among the plurality of pieces of retransmission information that causes the IQ multiplexing, the controller changes a combination used to transmit the retransmission information, to a combination that does not cause the IQ multiplexing among the combinations determined according to the rule as combinations that can be used to transmit the retransmission information.

17. The receiving method according to claim 15, wherein the changing the combination includes
selecting a first combination when the number of candidates of third retransmission information is 0, the third retransmission information being one of the plurality of pieces of retransmission information that causes the IQ multiplexing, the first combination being one of combinations determined according to the rule as combinations that can be used to transmit the third retransmission information, and
changing a combination used to transmit fourth retransmission information, to a second combination that does not cause the IQ multiplexing, the second combination being one of combinations determined according to the rule as combinations that can be used to transmit the fourth retransmission information, the fourth retransmission information causing the IQ multiplexing together with the retransmission information under an assumption that the retransmission information is transmitted by using the selected first combination or the fourth retransmission information being transmitted by using the selected first combination, and
changing to the first combination the combination used to transmit the third retransmission information.

18. The receiving method according to claim 15, wherein the changing the combination includes
obtaining a transmission power difference when the number of candidates for fifth retransmission information is 0, the fifth retransmission information being one of the plurality of pieces of retransmission information that causes the IQ multiplexing, the transmission power difference being a difference between transmission power of the fifth retransmission information and transmission power of retransmission information that causes the IQ multiplexing together with retransmission information under an assumption that the retransmission information is transmitted by using each of at least one combination determined according to the rule as combinations that can be used to transmit the fifth retransmission information, and
changing a combination used to transmit the fifth retransmission information, to a combination whose obtained transmission power difference is minimum.
